(19) United States
(12) Patent Application Publication
(10) Pub. No.: US 2026/0089725 A1
(43) Pub. Date: Mar. 26, 2026

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/889,431

(22) Filed: Sep. 19, 2024

Related U.S. Application Data
(63) Continuation of application No. PCT/CN2023/082447, filed on Mar. 20, 2023.

(30) Foreign Application Priority Data
Mar. 28, 2022 (CN) 202210317117.7

(51) Int. Cl. H04W 72/23; H04L 5/00

(52) U.S. Cl. CPC H04W 72/23; H04L 5/0098

(57) ABSTRACT

A first receiver receives a first signaling, the first signaling is used to schedule a first PDSCH; determines whether to process the first PDSCH according to a first condition set; when the first condition set is satisfied, processes the first PDSCH; when the first condition set is not satisfied, determines whether to process the first PDSCH by itself; wherein the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate.

### CROSS REFERENCE TO RELATED APPLICATIONS

This application is the continuation of the international patent application No. PCT/CN2023/082447, filed on Mar. 20, 2023, and claims the priority benefit of Chinese Patent Application CN202210317117.7, filed on Mar. 28, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

5G NR system supports diverse terminal devices, including conventional terminal devices, reduced capability terminal devices, and so on; how to implement support for reduced capability terminal devices is an important aspect of the 5G NR system.

### SUMMARY

To address the above problem, the present application provides a solution. It should be noted that the above description uses a scenario supporting a reduced capability terminal device as an example; the present application is equally applicable to other scenarios, such as communication scenarios of conventional terminal devices, eMBB, URLLC, IoT (Internet of Things), Internet of Vehicles (IoV), NTN (non-terrestrial networks), etc., where similar technical effects can be achieved. In addition, the adoption of a unified solution for different scenarios (including, but not limited to, scenarios supporting reduced capacity terminal devices, communication scenarios for conventional terminal devices, eMBB, URLLC, IoT, IoV, NTN) can also help to reduce the hardware complexity and cost, or to improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling, the first signaling being used to schedule a first Physical Downlink Shared Channel (PDSCH); determining whether to process the first PDSCH according to a first condition set; when the first condition set is satisfied, processing the first PDSCH; when the first condition set is not satisfied, determining whether to process the first PDSCH by itself;
herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one embodiment, advantages of the above method comprise: improving the flexibility of the base station side scheduling and improving the system performance.

In one embodiment, advantages of the above method comprise: enhancing support for reduced capability terminal devices.

In one embodiment, advantages of the above method comprise: ensuring that reduced capability terminal devices are not required to process excessive data.

In one embodiment, advantages of the above method comprise: determining a reasonable data rate according to the UE capability, which ensures the adaptability of the system.

In one embodiment, advantages of the above method comprise: being beneficial to improve spectral efficiency.

According to one aspect of the present application, the above method is characterized in that
the first reference data rate is equal to a product of a first scaling factor and the second reference data rate, and the first scaling factor is a non-negative number less than 1.

According to one aspect of the present application, the above method is characterized in that
the first reference data rate is associated with a maximum transmission bandwidth of a PDSCH.

According to one aspect of the present application, the above method is characterized in that
the second reference data rate is associated with a maximum transmission bandwidth configuration or a largest bandwidth supported in a given band or a band combination.

According to one aspect of the present application, the above method is characterized in that
the second condition set comprises: first information is received, and the first information is used to indicate a maximum transmission bandwidth of a PDSCH.

According to one aspect of the present application, the above method is characterized in that
the second condition set comprises: first information is transmitted, and the first information is used to indicate a maximum transmission bandwidth of a PDSCH.

According to one aspect of the present application, the above method is characterized in that
the second condition set comprises: first information is provided, and the first information is used to indicate a maximum transmission bandwidth of a PDSCH.

According to one aspect of the present application, the above method is characterized in that
when the second condition set is satisfied: for a serving cell to which the first PDSCH belongs, a maximum transmission bandwidth of a PDSCH supported is less than a largest bandwidth supported.

According to one aspect of the present application, the above method is characterized in that
the behavior of processing the first PDSCH comprises decoding a bit block in the first PDSCH.

The present application provides a method in a second node for wireless communications, comprising:
transmitting a first signaling, the first signaling being used to schedule a first PDSCH; a receiving end of the first signaling determining whether to process the first PDSCH according to a first condition set; when the first condition set is satisfied, processing the first PDSCH; when the first condition set is not satisfied, determining whether to process the first PDSCH by itself;
herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

According to one aspect of the present application, the above method is characterized in that
the first reference data rate is equal to a product of a first scaling factor and the second reference data rate, and the first scaling factor is a non-negative number less than 1.

According to one aspect of the present application, the above method is characterized in that
the first reference data rate is associated with a maximum transmission bandwidth of a PDSCH.

According to one aspect of the present application, the above method is characterized in that
the second reference data rate is associated with a maximum transmission bandwidth configuration or a largest bandwidth supported in a given band or a band combination.

According to one aspect of the present application, the above method is characterized in that
the second condition set comprises: first information is received by a receiving end of the first signaling, and the first information is used to indicate a maximum transmission bandwidth of a PDSCH.

According to one aspect of the present application, the above method is characterized in that
the second condition set comprises: first information is transmitted by a receiving end of the first signaling, and the first information is used to indicate a maximum transmission bandwidth of a PDSCH.

According to one aspect of the present application, the above method is characterized in that
the second condition set comprises: first information is provided by a receiving end of the first signaling, and the first information is used to indicate a maximum transmission bandwidth of a PDSCH.

According to one aspect of the present application, the above method is characterized in that
when the second condition set is satisfied: for a serving cell to which the first PDSCH belongs, a maximum transmission bandwidth of a PDSCH supported is less than a largest bandwidth supported.

According to one aspect of the present application, the above method is characterized in that
the behavior of processing the first PDSCH comprises decoding a bit block in the first PDSCH.

According to one aspect of the present application, the above method is characterized in comprising:
transmitting the first PDSCH.

The present application provides a first node for wireless communications, comprising:
a first receiver, receiving a first signaling, the first signaling being used to schedule a first PDSCH; determining whether to process the first PDSCH according to a first condition set; when the first condition set is satisfied, processing the first PDSCH; when the first condition set is not satisfied, determining whether to process the first PDSCH by itself;
herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

The present application provides a second node for wireless communications, comprising:
a second transmitter, transmitting a first signaling, the first signaling being used to schedule a first PDSCH; a receiving end of the first signaling determining whether to process the first PDSCH according to a first condition set; when the first condition set is satisfied, processing the first PDSCH; when the first condition set is not satisfied, determining whether to process the first PDSCH by itself;
herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

The present application provides a method in a first node for wireless communications, comprising:
receiving a first signaling, the first signaling being used to schedule a first physical uplink shared channel (PUSCH); the first node determining whether to process the first PUSCH according to a first condition set; when the first condition set is satisfied, processing the first PUSCH; when the first condition set is not satisfied, determining whether to process the first PUSCH by itself;
herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one embodiment, advantages of the above method comprise: improving the flexibility of the base station side scheduling and improving the system performance.

In one embodiment, advantages of the above method comprise: enhancing support for reduced capability end devices.

In one embodiment, advantages of the above method comprise: ensuring that reduced capability end devices are not required to process excessive data.

In one embodiment, advantages of the above method comprise: determining a reasonable data rate according to the UE capability, which ensures the adaptability of the system.

In one embodiment, advantages of the above method comprise: being beneficial to improve spectral efficiency.

According to one aspect of the present application, the above method is characterized in that
the first reference data rate is equal to a product of a first scaling factor and the second reference data rate, and the first scaling factor is a non-negative number less than 1.

According to one aspect of the present application, the above method is characterized in that
the first reference data rate is associated with a maximum transmission bandwidth of a PUSCH.

According to one aspect of the present application, the above method is characterized in that
the second reference data rate is associated with a maximum transmission bandwidth configuration or a largest bandwidth supported in a given band or a band combination.

According to one aspect of the present application, the above method is characterized in that
the second condition set comprises: first information is received, and the first information is used to indicate a maximum transmission bandwidth of a PUSCH.

According to one aspect of the present application, the above method is characterized in that
the second condition set comprises: first information is transmitted, and the first information is used to indicate a maximum transmission bandwidth of a PUSCH.

According to one aspect of the present application, the above method is characterized in that
the second condition set comprises: first information is provided, and the first information is used to indicate a maximum transmission bandwidth of a PUSCH.

According to one aspect of the present application, the above method is characterized in that
when the second condition set is satisfied: for a serving cell to which the first PUSCH belongs, a maximum transmission bandwidth of a PUSCH supported is less than a largest bandwidth supported.

The present application provides a method in a second node for wireless communications, comprising:
transmitting a first signaling, the first signaling being used to schedule a first PUSCH; a receiving end of the first signaling determining whether to process the first PUSCH according to a first condition set; when the first condition set is satisfied, processing the first PUSCH; when the first condition set is not satisfied, determining whether to process the first PUSCH by itself;
herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

According to one aspect of the present application, the above method is characterized in that
the first reference data rate is equal to a product of a first scaling factor and the second reference data rate, and the first scaling factor is a non-negative number less than 1.

According to one aspect of the present application, the above method is characterized in that
the first reference data rate is associated with a maximum transmission bandwidth of a PUSCH.

According to one aspect of the present application, the above method is characterized in that
the second reference data rate is associated with a maximum transmission bandwidth configuration or a largest bandwidth supported in a given band or a band combination.

According to one aspect of the present application, the above method is characterized in that
the second condition set comprises: first information is received by a receiving end of the first signaling, and the first information is used to indicate a maximum transmission bandwidth of a PUSCH.

According to one aspect of the present application, the above method is characterized in that
the second condition set comprises: first information is transmitted by a receiving end of the first signaling, and the first information is used to indicate a maximum transmission bandwidth of a PUSCH.

According to one aspect of the present application, the above method is characterized in that
the second condition set comprises: first information is provided by a receiving end of the first signaling, and the first information is used to indicate a maximum transmission bandwidth of a PUSCH.

According to one aspect of the present application, the above method is characterized in that
when the second condition set is satisfied: for a serving cell to which the first PUSCH belongs, a maximum transmission bandwidth of a PUSCH supported is less than a largest bandwidth supported.

The present application provides a first node for wireless communications, comprising:
a first receiver, receiving a first signaling, the first signaling being used to schedule a first PUSCH; the first node determining whether to process the first PUSCH according to a first condition set; when the first condition set is satisfied, processing the first PUSCH; when the first condition set is not satisfied, determining whether to process the first PUSCH by itself;
herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

The present application provides a second node for wireless communications, comprising:
a second transmitter, transmitting a first signaling, the first signaling being used to schedule a first PUSCH; a receiving end of the first signaling determines whether to process the first PUSCH according to a first condition set; when the first condition set is satisfied, processing the first PUSCH; when the first condition set is not satisfied, determining whether to process the first PUSCH by itself;
herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrates a schematic diagram of a first reference data rate according to one embodiment of the present application;

FIG. 7 illustrates a schematic diagram of a second reference data rate according to one embodiment of the present application;

FIG. 8 illustrates a schematic diagram of a relation between a first reference data rate and a second reference data rate according to one embodiment of the present application;

FIG. 9 illustrates a schematic diagram of a second condition set according to one embodiment of the present application;

FIG. 10 illustrates a schematic diagram of a second condition set according to one embodiment of the present application;

FIG. 11 illustrates a schematic diagram of a third condition set as well as related behaviors of the first node according to one embodiment of the present application;

FIG. 12 illustrates a flowchart of the processing of a first node according to one embodiment of the present application;

FIG. 13 illustrates a flowchart of signal transmission according to one embodiment of the present application;

FIG. 14 illustrates a structure block diagram of a processor in a first node according to one embodiment of the present application;

FIG. 15 illustrates a structure block diagram of a processor in second node according to one embodiment of the present application.

### DESCRIPTION OF THE EMBODIMENTS

The technical solution of the present application will be further described in detail below in combination with the drawings. It should be noted that, in the case of no conflict, the embodiments of the present application and the features in the embodiments may be combined with each other arbitrarily.

### Embodiment 1

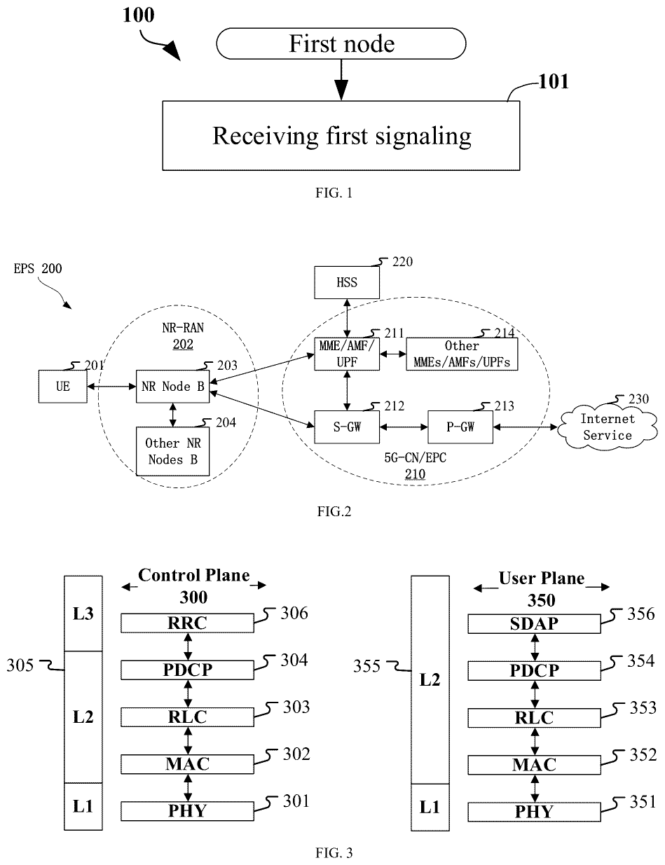

Embodiment 1 illustrates a flowchart of the processing of a first node according to one embodiment of the present application, as shown in FIG. 1.

In Embodiment 1, the first node in the present application receives a first signaling in step 101.

In embodiment 1, the first signaling is used to schedule a first PDSCH; determines whether to process the first PDSCH according to a first condition set; when the first condition set is satisfied, processes the first PDSCH; when the first condition set is not satisfied, determines whether to process the first PDSCH by itself; the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one embodiment, the first signaling is a physical-layer signaling.

In one embodiment, the first signaling is a downlink control signaling.

In one embodiment, the first signaling is a Downlink control information (DCI) format.

In one embodiment, the first signaling is a DCI signaling.

In one embodiment, the first node receives the first signaling in a physical layer control channel.

In one embodiment, the first node receives the first signaling in a PDCCH (Physical downlink control channel).

In one embodiment, the first signaling is DCI format 10, for the specific meaning of the DCI format 10, refer to chapter 7.3.1.2 in 3GPP TS38.212.

In one embodiment, the first signaling is DCI format 1_1, for the specific meaning of the DCI format 1_1, refer to chapter 7.3.1.2 in 3GPP TS38.212.

In one embodiment, the first signaling is DCI format 1_2, for the specific meaning of the DCI format 1_2, refer to chapter 7.3.1.2 in 3GPP TS38.212.

In one embodiment, the first signaling adopts DCI format 1_0.

In one embodiment, the first signaling adopts DCI format 1_1.

In one embodiment, the first signaling adopts DCI format 1_2.

In one embodiment, the first signaling adopts one of DCI format 10, DCI format 1_1 or DCI format 1_2.

In one embodiment, the first signaling is a DownLink Grant Signaling.

In one embodiment, the first signaling comprises a higher-layer signaling.

In one embodiment, the first signaling comprises an RRC signaling.

In one embodiment, the first signaling comprises an MAC CE.

In one embodiment, the first signaling indicates scheduling information of the first PDSCH; the scheduling information comprises at least one of occupied frequency-domain resources, occupied time-domain resources, MCS (Modulation and coding scheme), RV (Redundancy Version), TCI (Transmission Configuration Indicator) status, or occupied antenna ports.

In one embodiment, the first PDSCH is a Physical Downlink Shared Channel (PDSCH).

In one embodiment, the first PDSCH is a physical-layer channel.

In one embodiment, the first PDSCH is used for downlink.

In one embodiment, the first node receives the first PDSCH.

In one embodiment, the first node receives at least a part of the first PDSCH.

In one embodiment, the first PDSCH is only received when the first node determines processing the first PDSCH.

In one embodiment, the behavior of processing the first PDSCH comprises: decoding a bit block in the first PDSCH.

In one embodiment, the behavior of processing the first PDSCH comprises: the physical layer reports a decoding result of a bit block in the first PDSCH to a higher layer.

In one embodiment, the bit block in the first PDSCH is a transport block.

In one embodiment, the bit block in the first PDSCH is a code block.

In one embodiment, the bit block in the first PDSCH comprises at least one transport block.

In one embodiment, the bit block in the first PDSCH is comprises at least one code block.

In one embodiment, the bit block in the first PDSCH comprises multiple bits.

In one embodiment, the behavior of processing the first PDSCH comprises: receiving the first PDSCH.

In one embodiment, when all conditions in the first condition set are satisfied, the first condition set is satisfied.

In one embodiment, when any condition in the first condition set is satisfied, the first condition set is not satisfied.

In one embodiment, the first condition set comprises only one condition.

In one embodiment, the first condition set comprises multiple conditions.

In one embodiment, the first PDSCH is used for an initial transmission of a transport block (TB).

In one embodiment, the first PDSCH is used for a retransmission of a transport block.

In one embodiment, the expression of determining whether to process the first PDSCH by itself includes: not being required to process the first PDSCH.

In one embodiment, the expression of determining whether to process the first PDSCH by itself includes: self-determining whether to receive the first PDSCH.

In one embodiment, the expression of determining whether to process the first PDSCH by itself includes: self-determining whether to decode a bit block in the first PDSCH.

In one embodiment, the expression of determining whether to process the first PDSCH by itself includes: skipping decoding of a bit block in the first PDSCH and reporting unsuccessful decoding to higher layer by the physical layer.

In one embodiment, the expression of determining whether to process the first PDSCH by itself includes: whether to process the first PDSCH is implementation-related.

In one embodiment, the expression of determining whether to process the first PDSCH by itself includes: not processing the first PDSCH.

In one embodiment, the expression of determining whether to process the first PDSCH by itself includes: determining whether to process the first PDSCH according to a current decoding resource occupancy situation.

In one embodiment, the actual data rate is equal to a sum of J intermediate value(s), J being a positive integer, and one of the J intermediate value(s) is related to the number of bit(s) in the bit block of the first PDSCH.

In one embodiment, the number of bit(s) in the bit block in the first PDSCH is used to determine the actual data rate.

In one embodiment, the number of bit(s) in the bit block in the first PDSCH is used to calculate the actual data rate.

In one embodiment, the actual data rate is linearly correlated with the number of bit(s) in the bit block in the first PDSCH.

In one embodiment, the actual data rate is equal to

$${\sum }_{j = 0}^{J - 1} \frac{{\sum }_{m = 0}^{M - 1} {V}_{j , m}}{{T}_{slot}^{μ ( j )}} ,$$

j is one of 0, 1, . . . , J−1, each j corresponds to a serving cell, where J is a number of configured serving cell(s) belonging to a frequency range.

In one subembodiment of the above embodiment, for a j-th serving cell: M is a number of transport block(s) transmitted in a corresponding slot; Tₛₗₒₜ^{u(j)}=10⁻³/2^{μ(j)}, where μ(j) is a parameter numerology of a PDSCH in a corresponding slot; for an m-th transport block,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled by this transport block; the bit block in the first PDSCH is one of the M transport blocks.

In one embodiment, for a j-th serving cell, the corresponding slot is a slot overlapping with any given time point.

In one embodiment, J is equal to 1.

In one embodiment, J is greater than 1.

In one embodiment, J is configurable.

In one embodiment, the actual data rate is equal to

$$\frac{{\sum }_{m = 0}^{M - 1} {V}_{j , m}}{L \times {T}_{s}^{μ}} ,$$

where j corresponds to a serving cell to which the first PDSCH belongs, the L is a number of symbol(s) allocated to the first PDSCH, where M is a number of transport block(s) in the first PDSCH,

$${T}_{s}^{μ} = \frac{{10}^{- 3}}{{2}^{μ} \cdot {N}_{symb}^{slot}} ,$$

and μ is a parameter numerology of the first PDSCH; for an m-th transport block in the first PDSCH,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block.

In one embodiment, one condition in the first condition set is related to cache length.

In one embodiment, one condition in the first condition set is related to a number of symbol(s) allocated to the first PDSCH.

In one embodiment, one or multiple conditions in the first condition set are related to the first PDSCH.

In one embodiment, processingType2Enabled in a higher-layer parameter PDSCH-ServingCellConfig is configured to a serving cell to which the first PDSCH belongs and set to ‘enable’.

In one embodiment, processingType2Enabled in a higher-layer parameter PDSCH-ServingCellConfig is not configured to a serving cell to which the first PDSCH belongs.

In one embodiment, processingType2Enabled in a higher-layer parameter PDSCH-ServingCellConfig is configured to a serving cell to which the first PDSCH belongs and not set to ‘enable’.

In one embodiment, the first PDSCH is used for an initial transmission of a transport block.

In one embodiment, the first PDSCH is used for a retransmission of a transport block.

In one embodiment, when the actual data rate is greater than the target reference data rate, the first condition set is not satisfied.

In one embodiment, when all conditions in the second condition set are satisfied, the second condition set is satisfied.

In one embodiment, when any condition in the second condition set is satisfied, the second condition set is not satisfied.

In one embodiment, the second condition set comprises only one condition.

In one embodiment, the second condition set comprises multiple conditions.

In one embodiment, the expression that the second condition set is related to a transmission bandwidth of a PDSCH comprises: the second condition set is related to a maximum transmission bandwidth of a PDSCH.

In one embodiment, the expression that the second condition set is related to a transmission bandwidth of a PDSCH comprises: the second condition set is related to indication information of a maximum transmission bandwidth of a PDSCH.

In one embodiment, the expression that the second condition set is related to a transmission bandwidth of a PDSCH comprises: the second condition set is related to a limited transmission bandwidth for a PDSCH.

In one embodiment, the expression that the second condition set is related to a transmission bandwidth of a PDSCH comprises: the second condition set is related to indication information that a transmission bandwidth of a PDSCH is limited.

In one embodiment, the second condition set comprises: for a component carrier corresponding to the first PDSCH or a serving cell where the first PDSCH is located, a maximum transmission bandwidth of a PDSCH is configured.

In one embodiment, the second condition set comprises: a maximum transmission bandwidth of a PDSCH is reported for a component carrier corresponding to the first PDSCH or a serving cell where the first PDSCH is located.

In one embodiment, the expression that the second condition set is related to a transmission bandwidth of a PDSCH comprises: the second condition set comprises: first information is received, and the first information is used to indicate a maximum transmission bandwidth of a PDSCH.

In one embodiment, the expression that the second condition set is related to a transmission bandwidth of a PDSCH comprises: the second condition set comprises: first information is transmitted, and the first information is used to indicate a maximum transmission bandwidth of a PDSCH.

In one embodiment, the first node reports its own UE capabilities.

In one embodiment, the first node reports UE capability information element(s).

In one embodiment, the first reference data rate is equal to a ratio of the second reference data rate to a first scaling factor, and the first scaling factor is a positive number less than 1.

In one embodiment, the first reference data rate is equal to a ratio of the second reference data rate to a first scaling factor, and the first scaling factor is a positive number greater than 1.

In one embodiment, the first reference data rate is linearly correlated with the second reference data rate.

In one embodiment, the first reference data rate and the second reference data rate are respectively applicable to situations where the second condition set is satisfied and not satisfied.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, both the first node and the second node in the present application correspond to the UE 201, for example, V2X communications are performed between the first node and the second node.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, a bit block in the present application is generated by the SDAP sublayer 356.

In one embodiment, a bit block in the present application is generated by the RRC sublayer 306.

In one embodiment, a bit block in the present application is generated by the MAC sublayer 302.

In one embodiment, a bit block in the present application is generated by the MAC sublayer 352.

In one embodiment, a bit block in the present application is generated by the PHY 301.

In one embodiment, a bit block in the present application is generated by the PHY 351.

### Embodiment 4

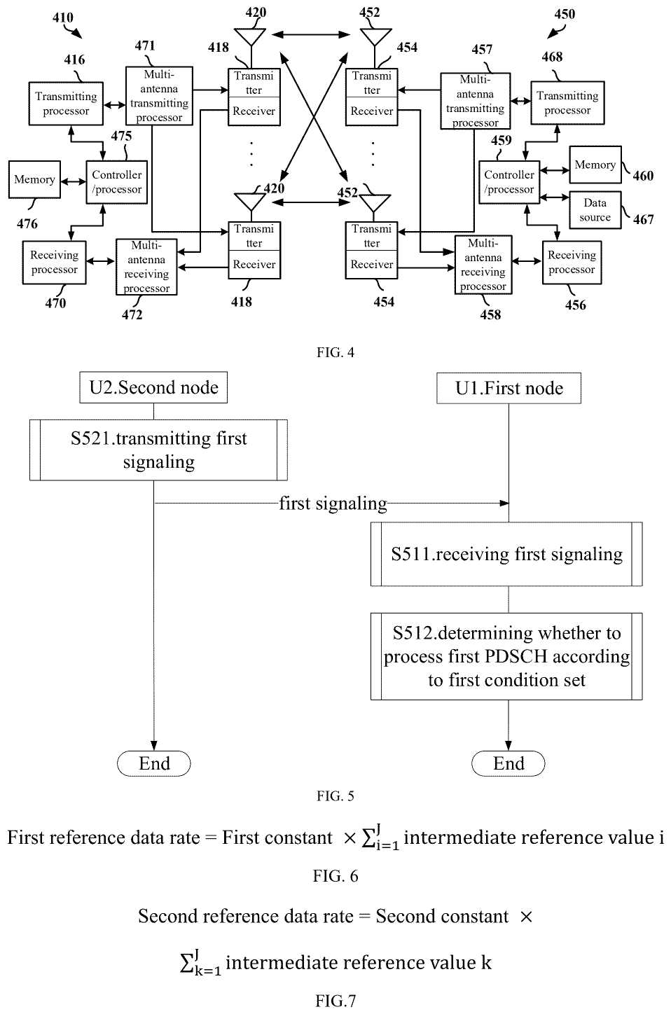

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling, the first signaling is used to schedule a first PDSCH; determines whether to process the first PDSCH according to a first condition set; when the first condition set is satisfied, processes the first PDSCH; when the first condition set is not satisfied, determines whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first signaling, the first signaling being used to schedule a first PDSCH; determining whether to process the first PDSCH according to a first condition set; when the first condition set is satisfied, processing the first PDSCH; when the first condition set is not satisfied, determining whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first signaling, the first signaling is used to schedule a first PDSCH; a receiving end of the first signaling determines whether to process the first PDSCH according to a first condition set; when the first condition set is satisfied, processes the first PDSCH; when the first condition set is not satisfied, determines whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first signaling, the first signaling being used to schedule a first PDSCH; a receiving end of the first signaling determining whether to process the first PDSCH according to a first condition set; when the first condition set is satisfied, processing the first PDSCH; when the first condition set is not satisfied, determining whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmission processor 458, the transmitting processor 468, the controller/processor 459, the memory 460, or the data source 467 is used to process the first PDSCH in the present application or is used to determine whether to process the first PDSCH in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling, the first signaling is used to schedule a first PUSCH; the first node determines whether to process the first PUSCH according to a first condition set; when the first condition set is satisfied, processes the first PUSCH; when the first condition set is not satisfied, determines whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first signaling, the first signaling being used to schedule a first PUSCH; the first node determining whether to process the first PUSCH according to a first condition set; when the first condition set is satisfied, processing the first PUSCH; when the first condition set is not satisfied, determining whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first signaling, the first signaling is used to schedule a first PUSCH; a receiving end of the first signaling determines whether to process the first PUSCH according to a first condition set; when the first condition set is satisfied, processes the first PUSCH; when the first condition set is not satisfied, determines whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first signaling, the first signaling being used to schedule a first PUSCH; a receiving end of the first signaling determining whether to process the first PUSCH according to a first condition set; when the first condition set is satisfied, processing the first PUSCH; when the first condition set is not satisfied, determining whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmission processor 458, the transmitting processor 468, the controller/processor 459, the memory 460, or the data source 467 is used to process the first PUSCH in the present application or is used to determine whether to process the first PUSCH in the present application.

### Embodiment 5

Embodiment 5 illustrates a flowchart of signal transmission according to one embodiment in the present application, as shown in FIG. 5. In FIG. 5, a first node U1 and a second node U2 are in communications via an air interface.

The first node U1 receives a first signaling in step S511; determines whether to process a first PDSCH according to a first condition set in step S512.

The second node U2 transmits a first signaling in step S521.

In embodiment 5, the first signaling is used to schedule the first PDSCH; when the first condition set is satisfied, process the first PDSCH; when the first condition set is not satisfied, determine whether to process the first PDSCH by itself; the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is associated with a maximum transmission bandwidth of a PDSCH; when a second condition set is not satisfied, the target reference data rate is a second reference data rate, and the second reference data rate is associated with a maximum transmission bandwidth configuration or a largest bandwidth supported in a given band or a band combination; the second condition set is related to a maximum transmission bandwidth of a PDSCH.

In one subembodiment of embodiment 5, the second condition set comprises: first information is received, and the first information is used to indicate a maximum transmission bandwidth of a PDSCH.

In one subembodiment of embodiment 5, the second condition set comprises: first information is provided, and the first information is used to indicate a maximum transmission bandwidth of a PDSCH.

In one subembodiment of embodiment 5, the second condition set comprises: first information is received, and the first information is used to indicate that a transmission bandwidth of a PDSCH is limited.

In one subembodiment of embodiment 5, the second condition set comprises: first information is provided, and the first information is used to indicate that a transmission bandwidth of a PDSCH is limited.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface.

In one embodiment, an air interface between the second node U2 and the first node U1 comprises sidelink.

In one embodiment, an air interface between the second node U2 and the first node U1 comprises a radio interface between a base station and a UE.

In one embodiment, an air interface between the second node U2 and the first node U1 comprises a radio interface between a satellite and a UE.

In one embodiment, an air interface between the second node U2 and the first node U1 comprises a radio interface between a UE and a UE.

In one embodiment, a problem to be solved in the present application comprises: how to achieve adaptability of processing for the PDSCH according to UE capabilities.

In one embodiment, a problem to be solved in the present application comprises: how to determine a data rate that UE needs to process after a transmission bandwidth of PDSCH is limited.

In one embodiment, a problem to be solved in the present application comprises: how to determine a data rate that the UE needs to process according to its capabilities.

In one embodiment, a problem to be solved in the present application comprises: how to determine whether to process a PDSCH according to a data rate for different UE capabilities.

In one embodiment, a problem to be solved in the present application comprises: how to achieve support for reduced capacity terminal devices.

In one embodiment, the second U2 also transmits the first PDSCH.

### Embodiment 6

Embodiment 6 illustrates a schematic diagram of a first reference data rate according to one embodiment of the present application, as shown in FIG. 6.

In embodiment 6, the first reference data rate is equal to a first constant multiplied by a sum of J intermediate reference value(s), each of the J intermediate reference value(s) corresponding to the first reference data rate is equal to a product of multiple values, and the J intermediate reference value(s) corresponding to the first reference data rate corresponds (respectively correspond) to different component carriers or different serving cells; a first given intermediate reference value is an intermediate reference value corresponding to a component carrier or serving cell to which the first PDSCH belongs among the J intermediate reference value(s) corresponding to the first reference data rate; for the first given intermediate reference value, one of the corresponding multiple values is equal to a maximum Resource Block (RB) allocation in a maximum transmission bandwidth of a PDSCH.

In one embodiment, the first reference data rate is associated with a maximum transmission bandwidth of a PDSCH in a frequency band or frequency band combination to which the first PDSCH belongs in frequency domain.

In one embodiment, the first reference data rate is associated with a maximum RB allocation in a maximum transmission bandwidth of a PDSCH in a frequency band or frequency band combination to which the first PDSCH belongs in frequency domain.

In one embodiment, the first reference data rate is associated with a maximum transmission bandwidth of a PDSCH in a serving cell to which the first PDSCH belongs.

In one embodiment, the first reference data rate is associated with a maximum RB allocation in a maximum transmission bandwidth of a PDSCH in a serving cell to which the first PDSCH belongs.

In one embodiment, the first reference data rate is associated with a maximum transmission bandwidth of a PDSCH in a BWP to which the first PDSCH belongs in frequency domain.

In one embodiment, the first reference data rate is associated with a maximum RB allocation in a maximum transmission bandwidth of a PDSCH in a BWP to which the first PDSCH belongs in frequency domain.

In one embodiment, the first constant is a positive number.

In one embodiment, the first constant is not greater than 1.

In one embodiment, the first constant is 10⁻⁶.

In one embodiment, the first reference data rate is a maximum data rate.

In one embodiment, the first reference data rate is a maximum data rate after considering that a transmission bandwidth of a PDSCH is limited.

In one embodiment, the first reference data rate is calculated as a maximum data rate for one carrier or for multiple carriers.

In one embodiment, the first reference data rate is calculated as: in a frequency band or frequency band combination, an approximate maximum data rate of a given number of aggregation carriers.

In one embodiment, the first reference data rate is computed as the maximum data rate summed over all the carriers in the frequency range for any signaled band combination and feature set consistent with the configured servings cells.

In one embodiment, the first reference data rate is calculated as a maximum data rate on one carrier.

In one embodiment, the first reference data rate is calculated as a maximum data rate on a carrier considering that a transmission bandwidth of a PDSCH is limited.

In one embodiment, the first reference data rate is calculated as the maximum data rate over a carrier within a frequency band of a serving cell to which the first PDSCH belongs considering that a transmission bandwidth of a PDSCH is limited.

In one embodiment, the first reference data rate is equal to 10⁻⁶ multiplied by a sum of J intermediate reference value(s), and each of the J intermediate reference value(s) corresponding to the first reference data rate is equal to a product of multiple values.

In one embodiment, when J is equal to 1, a sum of J intermediate reference value(s) refers to: only one intermediate reference value.

In one embodiment, J is equal to 1.

In one embodiment, J is greater than 1.

In one embodiment, J is a number of aggregated component carrier(s) in a frequency band or frequency band combination.

In one embodiment, J is a number of configured serving cell(s) belonging to a frequency range.

In one embodiment, the J intermediate reference value(s) corresponding to the first reference data rate corresponds (respectively correspond) to different component carriers.

In one embodiment, the J intermediate reference value(s) corresponding to the first reference data rate corresponds (respectively correspond) to different serving cells.

In one embodiment, a first given intermediate reference value among the J intermediate reference value(s) corresponding to the first reference data rate is equal to a product of multiple values.

In one embodiment, the first given intermediate reference value is any of the J intermediate reference value(s) corresponding to the first reference data rate.

In one embodiment, the first given intermediate reference value is an intermediate reference value corresponding to a component carrier corresponding to the first PDSCH among the J intermediate reference value(s) corresponding to the first reference data rate.

In one embodiment, the first given intermediate reference value is an intermediate reference value corresponding to a serving cell to which the first PDSCH belongs among the J intermediate reference value(s) corresponding to the first reference data rate.

In one embodiment, for each of the J intermediate reference value(s) corresponding to the first reference data rate, one of the corresponding multiple values is equal to a number of maximum transmission layers supported.

In one embodiment, for each of the J intermediate reference value(s) corresponding to the first reference data rate, one of the corresponding multiple values is equal to a number of maximum modulation orders supported.

In one embodiment, for each of the J intermediate reference value(s) corresponding to the first reference data rate, one of the corresponding multiple values is a scaling factor.

In one embodiment, for each of the J intermediate reference value(s) corresponding to the first reference data rate, one of the corresponding multiple values is constant 948/1024.

In one embodiment, for each of the J intermediate reference value(s) corresponding to the first reference data rate, one of the corresponding multiple values is constant 12.

In one embodiment, for each of the J intermediate reference value(s) corresponding to the first reference data rate, one of the corresponding multiple values is equal to 1/T1, and T1 is an average OFDM symbol duration in a subframe.

In one embodiment, for each of the J intermediate reference value(s) corresponding to the first reference data rate, one of the corresponding multiple values is equal to 1−OH1, where the OH1 is overhead.

In one embodiment, for each of the J intermediate reference value(s) corresponding to the first reference data rate, one of the multiple corresponding values is equal to a maximum RB allocation in a largest bandwidth supported in a given band or a band combination or a maximum RB allocation in a maximum transmission bandwidth of a PDSCH.

In one embodiment, the phrase of maximum RB allocation comprises: a number of resource block(s).

In one embodiment, the phrase of maximum RB allocation comprises: a number of allocated resource block(s).

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the first given intermediate reference value, one of the corresponding multiple values is configured by a transmitting end of the first signaling.

In one embodiment, for the first given intermediate reference value, one of the corresponding multiple values is reported by the first node.

In one embodiment, for the first given intermediate reference value, one of the corresponding multiple values is provided by the first node.

In one embodiment, for each of the J intermediate reference value(s) corresponding to the first reference data rate, one of the corresponding multiple values is UE-capability-related.

In one embodiment, for each of the J intermediate reference value(s) corresponding to the first reference data rate, one of the corresponding multiple values is a parameter value in a UE capability information element.

In one embodiment, the first reference data rate is determined by information configured by a transmitting end of the first signaling, or determined by information reported by the first node, or determined together by information reported by the first node and information configured by a transmitting end of the first signaling.

In one embodiment, a maximum transmission bandwidth of the PDSCH in the present application is: a maximum transmission bandwidth that a PDSCH can occupy.

In one embodiment, a maximum transmission bandwidth of the PDSCH in the present application is: a limited bandwidth for a PDSCH.

In one embodiment, a maximum transmission bandwidth of the PDSCH in the present application is: a transmission bandwidth used to limit frequency-domain resources occupied by a PDSCH.

In one embodiment, a maximum transmission bandwidth of the PDSCH in the present application is for a band or a band combination.

In one embodiment, a maximum transmission bandwidth of the PDSCH in the present application is for a serving cell.

In one embodiment, a maximum transmission bandwidth of the PDSCH in the present application is for a BWP.

In one embodiment, a maximum transmission bandwidth of a PDSCH in the present application is configured according to frequency band or frequency band combination.

In one embodiment, a maximum transmission bandwidth of a PDSCH in the present application is reported according to frequency band or frequency band combination.

In one embodiment, a maximum transmission bandwidth of a PDSCH in the present application is configured according to serving cell.

In one embodiment, a maximum transmission bandwidth of a PDSCH in the present application is reported according to serving cell.

In one embodiment, a maximum transmission bandwidth of a PDSCH in the present application is configured according to BWP.

In one embodiment, a maximum transmission bandwidth of a PDSCH in the present application is reported according to BWP.

In one embodiment, for a band or a band combination, a maximum transmission bandwidth of a PDSCH supported is equal to or less than a largest bandwidth supported.

In one embodiment, for a serving cell, a maximum transmission bandwidth of a PDSCH supported is equal to or less than a largest bandwidth supported.

In one embodiment, for a BWP, a maximum transmission bandwidth of a PDSCH supported is equal to or less than a largest bandwidth supported.

In one embodiment, when the second condition set is satisfied; for a band or a band combination to which the first PDSCH belongs in frequency domain, a maximum transmission bandwidth of a PDSCH supported is less than a largest bandwidth supported.

In one embodiment, when the second condition set is satisfied; for a serving cell to which the first PDSCH belongs, a maximum transmission bandwidth of a PDSCH supported is less than a largest bandwidth supported.

In one embodiment, when the second condition set is satisfied; for a BWP to which the first PDSCH belongs in frequency domain, a maximum transmission bandwidth of a PDSCH supported is less than a largest bandwidth supported.

### Embodiment 7

Embodiment 7 illustrates a schematic diagram of a second reference data rate according to one embodiment of the present application, as shown in FIG. 7.

In embodiment 7, the second reference data rate is equal to a second constant multiplied by a sum of J intermediate reference value(s), each of the J intermediate reference value(s) corresponding to the second reference data rate is equal to a product of multiple values, and the J intermediate reference value(s) corresponding to the second reference data rate corresponds (respectively correspond) to different component carriers or different serving cells; a second given intermediate reference value is an intermediate reference value corresponding to a component carrier corresponding to the first PDSCH or a serving cell to which it belongs among the J intermediate reference value(s) corresponding to the second reference data rate; for the second given intermediate reference value, one of the corresponding multiple values is equal to a maximum RB allocation in a largest bandwidth supported by a given frequency band or frequency band combination.

In one embodiment, the second reference data rate is associated with a largest bandwidth supported by the first PDSCH in a frequency band or frequency band combination to which it belongs in frequency domain.

In one embodiment, the second reference data rate is associated with a maximum RB allocation in a largest bandwidth supported by the first PDSCH in a frequency band or frequency band combination to which it belongs in frequency domain.

In one embodiment, the second reference data rate is associated with a largest bandwidth supported in a serving cell to which the first PDSCH belongs.

In one embodiment, the second reference data rate is associated with a maximum RB allocation in a largest bandwidth supported by a serving cell to which the first PDSCH belongs.

In one embodiment, the second constant is a positive number.

In one embodiment, the second constant is not greater than 1.

In one embodiment, the second constant is 10.

In one embodiment, the second constant is the first constant.

In one embodiment, the second reference data rate is greater than the first reference data rate.

In one embodiment, the second reference data rate is a maximum data rate.

In one embodiment, the second reference data rate is calculated as a maximum data rate for a carrier or for multiple carriers.

In one embodiment, the second reference data rate is calculated as: in a frequency band or frequency band combination, an approximate maximum data rate of a given number of aggregated carrier(s).

In one embodiment, the second reference data rate is computed as the maximum data rate summed over all the carriers in the frequency range for any signaled band combination and feature set consistent with the configured servings cells.

In one embodiment, the second reference data rate is calculated as a maximum data rate on a carrier.

In one embodiment, the second reference data rate is equal to 10⁻⁶ multiplied by a sum of J intermediate reference value(s), and each of the J intermediate reference value(s) corresponding to the second reference data rate is equal to a product of multiple values.

In one embodiment, when J is equal to 1, a sum of J intermediate reference value(s) refers to: only one intermediate reference value.

In one embodiment, J is equal to 1.

In one embodiment, J is greater than 1.

In one embodiment, J is a number of aggregated component carrier(s) in a frequency band or frequency band combination.

In one embodiment, J is a number of configured serving cell(s) belonging to a frequency range.

In one embodiment, the J intermediate reference value(s) corresponding to the second reference data rate corresponds (respectively correspond) to different component carriers.

In one embodiment, the J intermediate reference value(s) corresponding to the second reference data rate corresponds (respectively correspond) to different serving cells.

In one embodiment, a second given intermediate reference value among the J intermediate reference value(s) corresponding to the second reference data rate is equal to a product of multiple values.

In one embodiment, the second given intermediate reference value is any of the J intermediate reference value(s) corresponding to the second reference data rate.

In one embodiment, the second given intermediate reference value is an intermediate reference value corresponding to a component carrier corresponding to the first PDSCH among the J intermediate reference value(s) corresponding to the second reference data rate.

In one embodiment, the second given intermediate reference value is an intermediate reference value corresponding to a serving cell to which the first PDSCH belongs among the J intermediate reference value(s) corresponding to the second reference data rate.

In one embodiment, for each of the J intermediate reference value(s) corresponding to the second reference data rate, one of the corresponding multiple values is equal to a number of maximum transport layers supported.

In one embodiment, for each of the J intermediate reference value(s) corresponding to the second reference data rate, one of the corresponding multiple values is equal to a number of maximum modulation orders supported.

In one embodiment, for each of the J intermediate reference value(s) corresponding to the second reference data rate, one of the corresponding multiple values is a scaling factor.

In one embodiment, for each of the J intermediate reference value(s) corresponding to the second reference data rate, one of the corresponding multiple values is constant 948/1024.

In one embodiment, for each of the J intermediate reference value(s) corresponding to the second reference data rate, one of the corresponding multiple values is constant 12.

In one embodiment, for each of the J intermediate reference value(s) corresponding to the second reference data rate, one of the corresponding multiple values is equal to 1/T2, and T2 is an average OFDM symbol duration in a subframe.

In one embodiment, for each of the J intermediate reference value(s) corresponding to the second reference data rate, one of the corresponding multiple values is equal to 1−OH2, where OH2 is overhead.

In one embodiment, for each of the J intermediate reference value(s) corresponding to the second reference data rate, one of the corresponding multiple values is equal to a maximum RB allocation in a largest bandwidth supported in a given band or a band combination.

In one embodiment, for each of the J intermediate reference value(s) corresponding to the second reference data rate, one of the corresponding multiple values is equal to a maximum RB allocation in a largest bandwidth supported in a given band or a band combination or a maximum RB allocation in a maximum transmission bandwidth of a PDSCH.

In one embodiment, the phrase of maximum RB allocation comprises: a number of resource block(s).

In one embodiment, the phrase of maximum RB allocation comprises: a number of resource block(s) that can be allocated.

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the second given intermediate reference value, one of the corresponding multiple values is configured by a transmitting end of the first signaling.

In one embodiment, for the second given intermediate reference value, one of the corresponding multiple values is reported by the first node.

In one embodiment, for the second given intermediate reference value, one of the corresponding multiple values is provided by the first node.

In one embodiment, for each of the J intermediate reference value(s) corresponding to the second reference data rate, one of the corresponding multiple values is UE-capability related.

In one embodiment, for each of the J intermediate reference value(s) corresponding to the second reference data rate, one of the corresponding multiple values is a parameter value in a UE capability information element.

In one embodiment, the second reference data rate is determined by information configured by a transmitter of the first signaling, or by information reported by the first node, or together by information reported by the first node and information configured by a transmitter of the first signaling.

### Embodiment 8

Embodiment 8 illustrates a schematic diagram of a relation between a first reference data rate and a second reference data rate according to one embodiment of the present application, as shown in FIG. 8.

In embodiment 8, the first reference data rate is equal to a product of a first scaling factor and the second reference data rate.

In one embodiment, the first scaling factor is a non-negative number less than 1.

In one embodiment, the first scaling factor is configurable.

In one embodiment, the first scaling factor is reported by the first node.

In one embodiment, the first scaling factor is pre-configured.

In one embodiment, the first scaling factor is a constant.

In one embodiment, the first scaling factor is a positive number less than 1.

In one embodiment, the first scaling factor is indicated by a parameter in an information element.

In one embodiment, the first scaling factor is indicated by a field in an information element.

In one embodiment, the first reference data rate is equal to a product of a first scaling factor and the second reference data rate, and the first scaling factor is configurable.

In one embodiment, the first reference data rate is equal to a product of a first scaling factor and the second reference data rate, and the first scaling factor is provided by the first node.

In one embodiment, the first reference data rate is equal to a product of a first scaling factor and the second reference data rate, and the first scaling factor is determined based on information provided by the first node.

### Embodiment 9

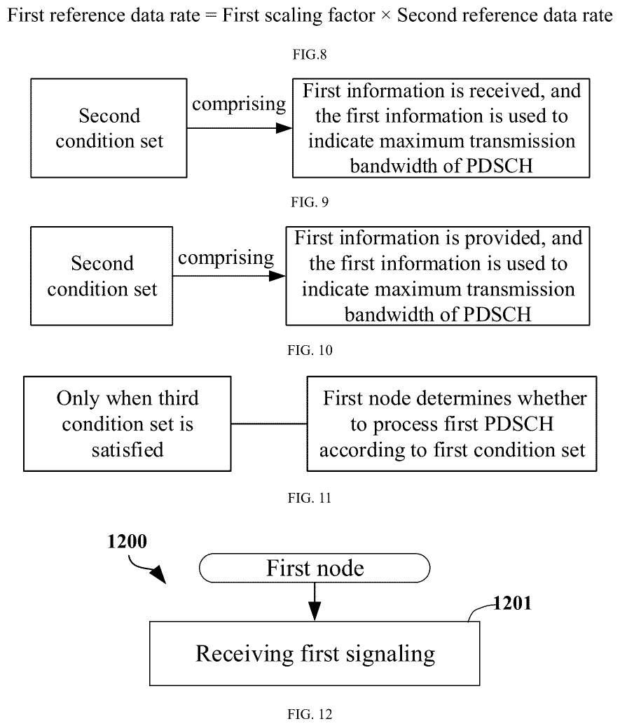

Embodiment 9 illustrates a schematic diagram of a second condition set according to one embodiment of the present application, as shown in FIG. 9.

In embodiment 9, the second condition set comprises: first information is received, and the first information is used to indicate a maximum transmission bandwidth of a PDSCH.

In one embodiment, the first information comprises a physical-layer signaling.

In one embodiment, the first information comprises an RRC signaling.

In one embodiment, the first information comprises a MAC CE.

In one embodiment, the first information comprises one or more fields in an information element.

In one embodiment, the first information is a higher-layer parameter.

In one embodiment, the first information is information for a component carrier corresponding to the first PDSCH or a serving cell where the first PDSCH is located.

In one embodiment, the second condition set not being satisfied comprises: the first node does not receive the first information.

In one embodiment, the second condition set comprises: first information is received, and the first information is used to indicate that a transmission bandwidth of a PDSCH is limited.

In one embodiment, the second condition set not being satisfied comprises: the first information is received, and the first information does not indicate that a transmission bandwidth of a PDSCH is limited.

In one embodiment, the second condition set not being satisfied comprises: the first information is not received, or the first information is received and the first information does not indicate that a transmission bandwidth of a PDSCH is limited.

In one embodiment, if the first node does not receive the first information, then the second condition set is not satisfied.

In one embodiment, the expression that the first information is received comprises: the first information is configured for the first node.

### Embodiment 10

Embodiment 10 illustrates a schematic diagram of a second condition set according to one embodiment of the present application, as shown in FIG. 10.

In embodiment 10, the second condition set comprises: first information is provided, and the first information is used to indicate a maximum transmission bandwidth of a PDSCH.

In one embodiment, the first information is information of a component carrier corresponding to the first PDSCH or a serving cell to which it belongs.

In one embodiment, the second condition set not being satisfied comprises: the first node does not transmit the first information.

In one embodiment, the second condition set comprises: first information is transmitted, and the first information is used to indicate that a transmission bandwidth of a PDSCH is limited.

In one embodiment, the phrase that a transmission bandwidth of a PDSCH is limited comprises: a maximum transmission bandwidth of a PDSCH is less than a maximum bandwidth supported.

In one embodiment, the second condition set not being satisfied comprises: the first information is transmitted, and the first information does not indicate that a transmission bandwidth of a PDSCH is limited.

In one embodiment, the second condition set not being satisfied comprises: the first information is not transmitted, or the first information is transmitted and the first information does not indicate that a transmission bandwidth of a PDSCH is limited.

In one embodiment, if the first node does not transmit the first information, then the second condition set is not satisfied.

In one embodiment, the second condition set comprises: first information is provided, and the first information is used to indicate a maximum transmission bandwidth of a PDSCH.

In one embodiment, the second condition set not being satisfied comprises: the first information is not provided.

In one embodiment, the second condition set comprises: first information is provided, and the first information is used to indicate that a transmission bandwidth of a PDSCH is limited.

In one embodiment, the second condition set not being satisfied comprises: the first information is provided, and the first information does not indicate that a transmission bandwidth of a PDSCH is limited.

In one embodiment, the second condition set not being satisfied comprises: the first information is not provided, or the first information is provided and the first information does not indicate that a transmission bandwidth of a PDSCH is limited.

In one embodiment, if the first node does not provide the first information, then the second condition set is not satisfied.

In one embodiment, the second condition set comprises: first information is transmitted, and the first information is used to indicate a maximum transmission bandwidth of a PDSCH.

In one embodiment, the second condition set not being satisfied comprises: the first information is not transmitted.

In one embodiment, the second condition set comprises: first information is transmitted, and the first information is used to indicate that a transmission bandwidth of a PDSCH is limited.

In one embodiment, the second condition set not being satisfied comprises: the first information is transmitted, and the first information does not indicate that a transmission bandwidth of a PDSCH is limited.

In one embodiment, the second condition set not being satisfied comprises: the first information is not transmitted, or the first information is transmitted and the first information does not indicate that a transmission bandwidth of a PDSCH is limited.

In one embodiment, if the first node does not transmit the first information, then the second condition set is not satisfied.

### Embodiment 11

Embodiment 11 illustrates a schematic diagram of a third condition set and related behaviors of the first node according to one embodiment of the present application, as shown in FIG. 11.

In embodiment 11, only when a third condition set is satisfied, the first node in the present application determines whether to process the first PDSCH according to the first condition set.

In one embodiment, a third condition set is a subset of the first condition set.

In one embodiment, when the third condition set is not satisfied, the first node determines whether to process the first PDSCH by itself.

In one embodiment, when all conditions in the third condition set are satisfied, the third condition set is satisfied.

In one embodiment, when any condition in the third condition set is satisfied, the third condition set is not satisfied.

In one embodiment, the third condition set comprises only one condition.

In one embodiment, the third condition set comprises multiple conditions.

In one embodiment, claims in the present application are for the case where a third condition set is satisfied.

In one embodiment, one condition in the third condition set is related to a number of code block(s) comprised in the first PDSCH.

In one embodiment, one condition in the third condition set is related to time-domain resources allocated to the first PDSCH.

In one embodiment, one condition in the third condition set is related to cache length.

In one embodiment, one condition in the third condition set comprises: during 14 continuous symbol durations under normal CP (or 12 continuous symbol durations under extended CP) that end with a last symbol transmitted by a last PDSCH within an activated BWP on a serving cell, ^{max(0,μ-μ′)}.

$${\sum }_{i ∈ S} ⌊ \frac{{C}_{i}^{′}}{{L}_{i}} ⌋ {x}_{i} \cdot {F}_{i} ⌈ \frac{x}{4} ⌉ \cdot \frac{1}{{R}_{LBRM}} .$$

TBS_{LBRM} is satisfied; S is a set of transport blocks belonging to all or part of the PDSCH comprised in the continuous symbol duration; for an i-th transport block, Cᵢ′ is a number of scheduled code block(s), and Li is a number of OFDM symbol(s) allocated to a PDSCH; xᵢ is a number of OFDM symbol(s) of a PDSCH comprised in the continuous symbol duration;

$${F}_{i} = {max}_{j = 0 , … , J - 1} ( min ( {k}_{0 , 1}^{j} + {E}_{i}^{j} , {N}_{cb , i} ) ) ,$$

where

$${k}_{0 , i}^{j}$$

is a starting position of an RV for a j-th transmission,

$${E}_{i}^{j} = min ( {E}_{r} )$$

is for a code block scheduled for a j-th transmission, N_{cb,i} is a circular buffer length, J−1 is a current (re) transmission of the i-th transmission block, μ′ corresponds to a subcarrier spacing of a BWP with a maximum PRB configuration(s)(among all configured BWPs of a carrier), μ corresponds to a subcarrier spacing of an activated BWP, R_{LBRM}=2/3, TBS_{LBRM} is defined in clause 5.4.2.1 in 3GPP TS 38.212, and X is the maximum number of transmission layer(s).

In one embodiment, the third condition set comprises: a second actual data rate is not greater than a third reference data rate.

In one embodiment, the second actual data rate is equal to a sum of J1 intermediate value(s), J1 being a positive integer, and one of the J1 intermediate value(s) is related to the number of bit(s) in the bit block of the first PDSCH.

In one embodiment, the number of bit(s) in the bit block in the first PDSCH is used to determine the second actual data rate.

In one embodiment, the number of bit(s) in the bit block in the first PDSCH is used to calculate the second actual data rate.

In one embodiment, the second actual data rate is linearly correlated with the number of bit(s) in the bit block in the first PDSCH.

In one embodiment, the second actual data rate is equal to

$${\sum }_{j = 0}^{J - 1} \frac{{\sum }_{m = 0}^{M - 1} {V}_{j , m}}{{T}_{slot}^{μ ( j )}} ,$$

j is one of 0, 1, . . . , J−1, each j corresponds to a serving cell, where J is a number of configured serving cell(s) belonging to a frequency range.

In one subembodiment of the above embodiment, for a j-th serving cell: M is a number of transport block(s) transmitted in a corresponding slot; Tₛₗₒₜ^{μ(j)}=10⁻³/2^{μ(j)}, where μ(j) is a parameter numerology of a PDSCH in a corresponding slot; for an m-th transport block,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block; the bit block in the first PDSCH is one of the M transport block(s).

In one embodiment, for a j-th serving cell, the corresponding slot is a slot overlapping with any given time point.

In one embodiment, the second actual data rate is equal to

$$\frac{{\sum }_{m = 0}^{M - 1} {v}_{j , m}}{L \times {T}_{s}^{μ}} ,$$

where j corresponds to a serving cell to which the first PDSCH belongs, the L is a number of symbol(s) allocated to the first PDSCH, where M is a number of transport block(s) in the first PDSCH,

$${T}_{s}^{μ} = \frac{{10}^{- 3}}{{2}^{μ} \cdot {N}_{symb}^{slot}} ,$$

and μ is a parameter numerology of the first PDSCH; for an m-th transport block in the first PDSCH,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block.

In one embodiment, the third reference data rate is equal to a third constant multiplied by a sum of J1 intermediate reference value(s), each intermediate reference value in the J1 intermediate reference value(s) corresponding to the third reference data rate is equal to a product of multiple values, and the J1 intermediate reference value(s) corresponding to the third reference data rate corresponds (respectively correspond) to different component carriers or different serving cells; a third given intermediate reference value is an intermediate reference value corresponding to a component carrier corresponding to the first PDSCH or a serving cell to which it belongs among the J1 intermediate reference value(s) corresponding to the third reference data rate; for the third given intermediate reference value, one of the corresponding multiple values is equal to a maximum RB allocation in a largest bandwidth supported in a given frequency band or frequency band combination.

In one embodiment, the third reference data rate is associated with the supported maximum bandwidth in a band or band combination where the first PDSCH is located in frequency domain.

In one embodiment, the third reference data rate is associated with a maximum RB allocation in the supported maximum bandwidth in a band or band combination where the first PDSCH is located in frequency domain.

In one embodiment, the third reference data rate is associated with a largest bandwidth supported in a serving cell to which the first PDSCH belongs.

In one embodiment, the third reference data rate is associated with a maximum RB allocation in a largest bandwidth supported in a serving cell to which the first PDSCH belongs.

In one embodiment, the third constant is a positive number.

In one embodiment, the third constant is not greater than 1.

In one embodiment, the third constant is 10⁻⁶.

In one embodiment, the third reference data rate is a maximum data rate.

In one embodiment, the third reference data rate is calculated as a maximum data rate for one carrier or a maximum data rate for multiple carriers.

In one embodiment, the third reference data rate is calculated as: in a frequency band or frequency band combination, an approximate maximum data rate of a given number of aggregation carrier(s).

In one embodiment, the third reference data rate is computed as the maximum data rate summed over all the carriers in the frequency range for any signaled band combination and feature set consistent with the configured servings cells.

In one embodiment, the third reference data rate is calculated as a maximum data rate on a carrier.

In one embodiment, the third reference data rate is equal to 10⁻⁶ multiplied by a sum of J intermediate reference value(s), and each intermediate reference value in the J1 intermediate reference value(s) corresponding to the third reference data rate is equal to a product of multiple values.

In one embodiment, when J1 is equal to 1, a sum of J1 intermediate reference value(s) refers to: only one intermediate reference value.

In one embodiment, J1 is equal to 1.

In one embodiment, J1 is greater than 1.

In one embodiment, J1 is equal to J.

In one embodiment, J1 is not equal to J.

In one embodiment, J1 is a number of aggregated component carrier(s) in a frequency band or frequency band combination.

In one embodiment, J1 is a number of configured serving cell(s) belonging to a frequency range.

In one embodiment, the J1 intermediate reference value(s) corresponding to the third reference data rate corresponds (respectively correspond) to different component carriers.

In one embodiment, the J1 intermediate reference value(s) corresponding to the third reference data rate corresponds (respectively correspond) to different serving cells.

In one embodiment, a third given intermediate reference value among the J intermediate reference value(s) corresponding to the third reference data rate is equal to a product of multiple values.

In one embodiment, the third given intermediate reference value is any of the J1 intermediate reference value(s) corresponding to the third reference data rate.

In one embodiment, the third given intermediate reference value is an intermediate reference value corresponding to a component carrier corresponding the first PDSCH among the J1 intermediate reference value(s) corresponding to the third reference data rate.

In one embodiment, the third given intermediate reference value is an intermediate reference value corresponding to a serving cell to which the first PDSCH belongs among the J1 intermediate reference value(s) corresponding to the third reference data rate.

In one embodiment, for each of the J1 intermediate reference value(s) corresponding to the third reference data rate, one of the corresponding multiple values is equal to a maximum number of transmission layers supported.

In one embodiment, for each of the J1 intermediate reference value(s) corresponding to the third reference data rate, one of the corresponding multiple values is equal to a number of maximum modulation orders supported.

In one embodiment, for each of the J1 intermediate reference value(s) corresponding to the third reference data rate, one of the corresponding multiple values is a scaling factor.

In one embodiment, for each of the J1 intermediate reference value(s) corresponding to the third reference data rate, one of the corresponding multiple values is constant 948/1024.

In one embodiment, for each of the J1 intermediate reference value(s) corresponding to the third reference data rate, one of the corresponding multiple values is constant 12.

In one embodiment, for each of the J1 intermediate reference value(s) corresponding to the third reference data rate, one of the corresponding multiple values is equal to 1/T3, and the T3 is an average OFDM symbol duration in a subframe.

In one embodiment, for each of the J1 intermediate reference value(s) corresponding to the third reference data rate, one of the corresponding multiple values is equal to 1−OH3, and the OH3 is overhead.

In one embodiment, for each of the J1 intermediate reference value(s) corresponding to the third reference data rate, one of the multiple corresponding values is equal to a maximum RB allocation in a largest bandwidth supported in a given band or a band combination.

In one embodiment, for each of the J1 intermediate reference value(s) corresponding to the third reference data rate, one of the multiple corresponding values is equal to a maximum RB allocation in a largest bandwidth supported in a given band or a band combination or a maximum RB allocation in a maximum transmission bandwidth of a PDSCH.

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the third given intermediate reference value, one of the corresponding multiple values is configured by a transmitting end of the first signaling.

In one embodiment, for the third given intermediate reference value, one of the corresponding multiple values is reported by the first node.

In one embodiment, for the third given intermediate reference value, one of the corresponding multiple values is provided by the first node.

In one embodiment, for each of the J1 intermediate reference value(s) corresponding to the third reference data rate, one of the corresponding multiple values is related to the UE capability.

In one embodiment, for each of the J1 intermediate reference value(s) corresponding to the third reference data rate, one of the corresponding multiple values is a parameter value in the UE capability information element.

In one embodiment, the third reference data rate is determined by information configured by a transmitting end of the first signaling, or determined by information reported by the first node, or determined together by information reported by the first node and information configured by a transmitting end of the first signaling.

### Embodiment 12

Embodiment 12 illustrates a processing flowchart of a first node according to one embodiment of the present application, as shown in FIG. 12.

In Embodiment 12, the first node in the present application receives a first signaling in step 1201.

In embodiment 12, the first signaling is used to schedule a first PUSCH; the first node in the present application determines whether to process the first PUSCH according to a first condition set; when the first condition set is satisfied, processes the first PUSCH; when the first condition set is not satisfied, determines whether to process the first PUSCH by itself; the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one embodiment, the first signaling is a physical-layer signaling.

In one embodiment, the first signaling is a downlink control signaling.

In one embodiment, the first signaling is a Downlink Control Information (DCI) format.

In one embodiment, the first signaling is a DCI signaling.

In one embodiment, the first node receives the first signaling in a physical layer control channel.

In one embodiment, the first node receives the first signaling in a PDCCH (Physical downlink control channel).

In one embodiment, the first signaling is DCI format 00, for the specific meaning of the DCI format 0_0, refer to clause 7.3.1.1 in 3GPP TS38.212.

In one embodiment, the first signaling is DCI format 0_1, for the specific meaning of the DCI format 0_1, refer to clause 7.3.1.1 in 3GPP TS38.212.

In one embodiment, the first signaling is DCI format 0_2, for the specific meaning of the DCI format 0_2, refer to clause 7.3.1.1 in 3GPP TS38.212.

In one embodiment, the first signaling adopts DCI format 0_0.

In one embodiment, the first signaling adopts DCI format 0_1.

In one embodiment, the first signaling adopts DCI format 0_2.

In one embodiment, the first signaling adopts one of DCI format 0_0, DCI format 0_1 or DCI format 0_2.

In one embodiment, the first signaling is an UpLink Grant Signaling.

In one embodiment, the first signaling comprises a higher-layer signaling.

In one embodiment, the first signaling comprises an RRC signaling.

In one embodiment, the first signaling comprises a MAC CE.

In one embodiment, the first signaling indicates scheduling information of the first PUSCH; the scheduling information comprises at least one of occupied frequency-domain resources, occupied time-domain resources, MCS (Modulation and coding scheme), RV (Redundancy Version), precoding information, or occupied antenna ports.

In one embodiment, the first PUSCH is a PUSCH.

In one embodiment, the first PUSCH is a physical-layer channel.

In one embodiment, the first PUSCH is used for uplink.

In one embodiment, the first node transmits the first PUSCH.

In one embodiment, the first node transmits at least a part of the first PUSCH.

In one embodiment, only when the first node determines to process the first PUSCH, will it transmit the first PUSCH.

In one embodiment, the bit block in the first PUSCH is a transport block.

In one embodiment, the bit block in the first PUSCH is a code block.

In one embodiment, the bit block in the first PUSCH comprises at least one transport block.

In one embodiment, the bit block in the first PUSCH comprises at least one code block.

In one embodiment, the bit block in the first PUSCH comprises multiple bits.

In one embodiment, when all conditions in the first condition set are satisfied, the first condition set is satisfied.

In one embodiment, when any condition in the first condition set is satisfied, the first condition set is not satisfied.

In one embodiment, the first condition set comprises only one condition.

In one embodiment, the first condition set comprises multiple conditions.

In one embodiment, the first PUSCH is used for an initial transmission of a transport block (TB).

In one embodiment, the first PUSCH is used for a retransmission of a transport block.

In one embodiment, the behavior of processing the first PUSCH comprises: encoding bit blocks in the first PUSCH.

In one embodiment, the behavior of processing the first PUSCH comprises: transmitting the first PUSCH.

In one embodiment, the expression of determining whether to process the first PUSCH includes: not being required to process the first PUSCH.

In one embodiment, the expression of determining whether to process the first PUSCH includes: self-determining whether to transmit the first PUSCH.

In one embodiment, the expression of determining whether to process the first PUSCH includes: self-determining whether to perform encoding on bit blocks in the first PUSCH.

In one embodiment, the expression of determining whether to process the first PUSCH includes: skipping encoding of bit blocks in the first PUSCH.

In one embodiment, the expression of determining whether to process the first PUSCH includes: whether to process the first PUSCH is implementation-related.

In one embodiment, the expression of determining whether to process the first PUSCH includes: not processing the first PUSCH.

In one embodiment, the expression of determining whether to process the first PUSCH includes: determining whether to process the first PUSCH according to current resource occupancy situation.

In one embodiment, the actual data rate is equal to a sum of J intermediate value(s), where J is a positive integer, and one of the J intermediate value(s) is related to the number of bit(s) in the bit block in the first PUSCH.

In one embodiment, the number of bit(s) in the bit block in the first PUSCH is used to determine the actual data rate.

In one embodiment, the number of bit(s) in the bit block in the first PUSCH is used to calculate the actual data rate.

In one embodiment, the actual data rate is linearly correlated with the number of bit(s) in the bit block in the first PUSCH.

In one embodiment, the actual data rate is equal to

$${\sum }_{j = 0}^{J - 1} \frac{{\sum }_{m = 0}^{M - 1} {V}_{j , m}}{{T}_{slot}^{μ ( j )}} ,$$

j is one of 0, 1, . . . , J−1, each j corresponds to a serving cell, where J is a number of configured serving cell(s) belonging to a frequency range.

In one subembodiment of the above embodiment, for a j-th serving cell: M is a number of transport block(s) transmitted in a corresponding slot; Tₛₗₒₜ^{μ(j)}=10⁻³/2^{μ(j)}, where μ(j) is a parameter numerology of a PUSCH in a corresponding slot; for an m-th transport block,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block; the bit block in the first PUSCH is one of the M transport block(s).

In one embodiment, for a j-th serving cell, the corresponding slot is a slot overlapping with any given time point.

In one embodiment, J is equal to 1.

In one embodiment, J is greater than 1.

In one embodiment, J is configurable.

In one embodiment, the actual data rate is equal to

$$\frac{{\sum }_{m = 0}^{M - 1} {v}_{j , m}}{L \times {T}_{s}^{μ}} ,$$

j corresponds to a serving cell to which the first PUSCH belongs, L is a number of symbol(s) allocated to the first PUSCH, M is a number of transport block(s) in the first PUSCH,

$${T}_{s}^{μ} = \frac{{10}^{- 3}}{{2}^{μ} \cdot {N}_{symb}^{slot}} ,$$

where μ is a parameter numerology of the first PUSCH; for an m-th transport block in the first PUSCH,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block.

In one embodiment, one condition in the first condition set is related to cache length.

In one embodiment, one condition in the first condition set is related to a number of symbol(s) allocated to the first PUSCH.

In one embodiment, one or multiple conditions in the first condition set are related to the first PUSCH.

In one embodiment, processingType2Enabled in a higher-layer parameter PUSCH-ServingCellConfig is configured to a serving cell to which the first PUSCH belongs and set as ‘enable’.

In one embodiment, processingType2Enabled in a higher-layer parameter PUSCH-ServingCellConfig is not configured to a serving cell to which the first PUSCH belongs.

In one embodiment, processingType2Enabled in a higher-layer parameter PUSCH-ServingCellConfig is configured to a serving cell to which the first PUSCH belongs and not set as ‘enable’.

In one embodiment, the first PUSCH is used for an initial transmission of a transport block.

In one embodiment, the first PUSCH is used for a retransmission of a transport block.

In one embodiment, when the actual data rate is greater than the target reference data rate, the first condition set is not satisfied.

In one embodiment, when all conditions in the second condition set are satisfied, the second condition set is satisfied.

In one embodiment, when any condition in the second condition set is satisfied, the second condition set is not satisfied.

In one embodiment, the second condition set comprises only one condition.

In one embodiment, the second condition set comprises multiple conditions.

In one embodiment, the expression that the second condition set is related to a transmission bandwidth of a PUSCH comprises: the second condition set is related to a maximum transmission bandwidth of a PUSCH.

In one embodiment, the expression that the second condition set is related to a transmission bandwidth of a PUSCH comprises: the second condition set is related to indication information of a maximum transmission bandwidth of a PUSCH.

In one embodiment, the expression that the second condition set is related to a transmission bandwidth of a PUSCH comprises: the second condition set is related to a limited transmission bandwidth for a PUSCH.

In one embodiment, the expression that the second condition set is related to a transmission bandwidth of a PUSCH comprises: the second condition set is related to indication information that a transmission bandwidth of a PUSCH is limited.

In one embodiment, the second condition set comprises: a maximum transmission bandwidth of a PUSCH is configured for a component carrier corresponding to the first PUSCH or a serving cell it belongs to.

In one embodiment, the second condition set comprises: a maximum transmission bandwidth of a PUSCH is reported for a component carrier corresponding to the first PUSCH or a serving cell it belongs to.

In one embodiment, the expression that the second condition set is related to a transmission bandwidth of a PUSCH comprises: the second condition set comprises: first information is received, and the first information is used to indicate a maximum transmission bandwidth of a PUSCH.

In one embodiment, the expression that the second condition set is related to a transmission bandwidth of a PUSCH comprises: the second condition set comprises: first information is transmitted, and the first information is used to indicate a maximum transmission bandwidth of a PUSCH.

In one embodiment, the first node reports its own UE capabilities.

In one embodiment, the first node reports UE capability information element(s).

In one embodiment, the first reference data rate is equal to a ratio of the second reference data rate to a first scaling factor, and the first scaling factor is a positive number less than 1.

In one embodiment, the first reference data rate is equal to a ratio of the second reference data rate to a first scaling factor, and the first scaling factor is a positive number greater than 1.

In one embodiment, the first reference data rate is linearly correlated with the second reference data rate.

In one embodiment, the first reference data rate and the second reference data rate are respectively for situations where the second condition set is satisfied and not satisfied.

In one embodiment, the first reference data rate is equal to a first constant multiplied by a sum of J intermediate reference value(s), each of the J intermediate reference value(s) corresponding to the first reference data rate is equal to a product of multiple values, and the J intermediate reference value(s) corresponding to the first reference data rate corresponds (respectively correspond) to different component carriers or different serving cells; a first given intermediate reference value is an intermediate reference value corresponding to a component carrier corresponding to the first PUSCH or a serving cell to which it belongs among the J intermediate reference value(s) corresponding to the first reference data rate; for the first given intermediate reference value, one of the corresponding multiple values is equal to a maximum RB allocation in a maximum transmission bandwidth of a PUSCH.

In one embodiment, the first reference data rate is associated with a maximum transmission bandwidth of a PUSCH in a frequency band or frequency band combination to which the first PUSCH belongs in frequency domain.

In one embodiment, the first reference data rate is associated with a maximum RB allocation in a maximum transmission bandwidth of a PUSCH in a frequency band or frequency band combination to which the first PUSCH belongs in frequency domain.

In one embodiment, the first reference data rate is associated with a maximum transmission bandwidth of a PUSCH in a serving cell to which the first PUSCH belongs.

In one embodiment, the first reference data rate is associated with a maximum RB allocation in a maximum transmission bandwidth of a PUSCH in a serving cell to which the first PUSCH belongs.

In one embodiment, the first reference data rate is associated with a maximum transmission bandwidth of a PUSCH in a BWP to which the first PUSCH belongs in frequency domain.

In one embodiment, the first reference data rate is associated with a maximum RB allocation in a maximum transmission bandwidth of a PUSCH in a BWP to which the first PUSCH belongs in frequency domain.

In one embodiment, the first constant is a positive number.

In one embodiment, the first constant is not greater than 1.

In one embodiment, the first constant is 10⁻⁶.

In one embodiment, the first reference data rate is a maximum data rate.

In one embodiment, the first reference data rate is a maximum data rate considering that a PUSCH transmission bandwidth is limited.

In one embodiment, the first reference data rate is calculated as a maximum data rate for one carrier or a maximum data rate for multiple carriers.

In one embodiment, the first reference data rate is calculated as: in a frequency band or frequency band combination, an approximate maximum data rate of a given number of aggregation carrier(s).

In one embodiment, the first reference data rate is computed as the maximum data rate summed over all the carriers in the frequency range for any signaled band combination and feature set consistent with the configured servings cells.

In one embodiment, the first reference data rate is calculated as a maximum data rate on a carrier.

In one embodiment, the first reference data rate is calculated as a maximum data rate on a carrier considering that a PUSCH transmission bandwidth is limited.

In one embodiment, the first reference data rate is calculated as a maximum data rate on a carrier within a frequency band of a serving cell to which the first PUSCH belongs after considering that a transmission bandwidth of a PUSCH is limited.

In one embodiment, the first reference data rate is equal to 10⁻⁶ multiplied by a sum of J intermediate reference value(s), and each of the J intermediate reference value(s) corresponding to the first reference data rate is equal to a product of multiple values.

In one embodiment, when J is equal to 1, a sum of J intermediate reference value(s) refers to: only one intermediate reference value.

In one embodiment, J is equal to 1.

In one embodiment, J is greater than 1.

In one embodiment, J is a number of aggregated component carrier(s) in a frequency band or frequency band combination.

In one embodiment, J is a number of configured serving cell(s) belonging to a frequency range.

In one embodiment, the J intermediate reference value(s) corresponding to the first reference data rate corresponds (respectively correspond) to different component carriers.

In one embodiment, the J intermediate reference value(s) corresponding to the first reference data rate corresponds (respectively correspond) to different serving cells.

In one embodiment, a first given intermediate reference value among the J intermediate reference value(s) corresponding to the first reference data rate is equal to a product of multiple values.

In one embodiment, the first given intermediate reference value is any of the J intermediate reference value(s) corresponding to the first reference data rate.

In one embodiment, the first given intermediate reference value is an intermediate reference value corresponding to a component carrier corresponding to the first PUSCH among the J intermediate reference value(s) corresponding to the first reference data rate.

In one embodiment, the first given intermediate reference value is an intermediate reference value corresponding to a serving cell to which the first PUSCH belongs among the J intermediate reference value(s) corresponding to the first reference data rate.

In one embodiment, for each of the J intermediate reference value(s) corresponding to the first reference data rate, one of the corresponding multiple values is equal to a number of maximum transmission layers supported.

In one embodiment, for each of the J intermediate reference value(s) corresponding to the first reference data rate, one of the corresponding multiple values is equal to a number of maximum modulation orders supported.

In one embodiment, for each of the J intermediate reference value(s) corresponding to the first reference data rate, one of the corresponding multiple values is a scaling factor.

In one embodiment, for each of the J intermediate reference value(s) corresponding to the first reference data rate, one of the corresponding multiple values is constant 948/1024.

In one embodiment, for each of the J intermediate reference value(s) corresponding to the first reference data rate, one of the corresponding multiple values is constant 12.

In one embodiment, for each of the J intermediate reference value(s) corresponding to the first reference data rate, one of the corresponding multiple values is equal to 1/T1, and T1 is an average OFDM symbol duration in a subframe.

In one embodiment, for each of the J intermediate reference value(s) corresponding to the first reference data rate, one of the corresponding multiple values is equal to 1−OH1, where the OH1 is overhead.

In one embodiment, for each of the J intermediate reference value(s) corresponding to the first reference data rate, one of the multiple corresponding values is equal to a maximum RB allocation in a largest bandwidth supported in a given band or a band combination or a maximum RB allocation in a maximum transmission bandwidth of a PUSCH.

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the first given intermediate reference value, one of the corresponding multiple values is configured by a transmitting end of the first signaling.

In one embodiment, for the first given intermediate reference value, one of the corresponding multiple values is reported by the first node.

In one embodiment, for the first given intermediate reference value, one of the corresponding multiple values is provided by the first node.

In one embodiment, for each of the J intermediate reference value(s) corresponding to the first reference data rate, one of the corresponding multiple values is UE-capability related.

In one embodiment, for each of the J intermediate reference value(s) corresponding to the first reference data rate, one of the corresponding multiple values is a parameter value in a UE capability information element.

In one embodiment, the first reference data rate is determined by information configured by a transmitting end of the first signaling, or determined by information reported by the first node, or determined together by information reported by the first node and information configured by a transmitting end of the first signaling.

In one embodiment, a maximum transmission bandwidth of the PUSCH in the present application is: a maximum transmission bandwidth that a PUSCH can occupy.

In one embodiment, a maximum transmission bandwidth of the PUSCH in the present application is: a limited bandwidth for a PUSCH.

In one embodiment, a maximum transmission bandwidth of the PUSCH in the present application is: a transmission bandwidth used to limit frequency-domain resources occupied by a PUSCH.

In one embodiment, a maximum transmission bandwidth of the PUSCH in the present application is for a band or a band combination.

In one embodiment, a maximum transmission bandwidth of the PUSCH in the present application is for a serving cell.

In one embodiment, a maximum transmission bandwidth of the PUSCH in the present application is for a BWP.

In one embodiment, a maximum transmission bandwidth of the PUSCH in the present application is configured according to frequency band or frequency band combination.

In one embodiment, a maximum transmission bandwidth of the PUSCH in the present application is reported according to frequency band or frequency band combination.

In one embodiment, a maximum transmission bandwidth of the PUSCH in the present application is configured according to serving cell.

In one embodiment, a maximum transmission bandwidth of the PUSCH in the present application is reported according to serving cell.

In one embodiment, a maximum transmission bandwidth of the PUSCH in the present application is configured according to BWP.

In one embodiment, a maximum transmission bandwidth of the PUSCH in the present application is reported according to BWP.

In one embodiment, for a band or a band combination, a maximum transmission bandwidth supported of a PUSCH is equal to or less than a largest bandwidth supported.

In one embodiment, for a serving cell, a maximum transmission bandwidth supported of a PUSCH is equal to or less than a largest bandwidth supported.

In one embodiment, for a BWP, a maximum transmission bandwidth supported of a PUSCH is equal to or less than a largest bandwidth supported.

In one embodiment, when the second condition set is satisfied; for a band or a band combination to which the first PUSCH belongs in frequency domain, a maximum transmission bandwidth supported of a PUSCH is shorter than a largest bandwidth supported.

In one embodiment, when the second condition set is satisfied; for a serving cell to which the first PUSCH belongs, a maximum transmission bandwidth supported of a PUSCH is shorter than a largest bandwidth supported.

In one embodiment, when the second condition set is satisfied; for a BWP to which the first PUSCH belongs in frequency domain, a maximum transmission bandwidth supported of a PUSCH is shorter than a largest bandwidth supported.

In one embodiment, the second reference data rate is equal to a second constant multiplied by a sum of J intermediate reference value(s), each of the J intermediate reference value(s) corresponding to the second reference data rate is equal to a product of multiple values, and the J intermediate reference value(s) corresponding to the second reference data rate corresponds (respectively correspond) to different component carriers or different serving cells; a second given intermediate reference value is an intermediate reference value corresponding to a component carrier corresponding to the first PUSCH or a serving cell to which it belongs among the J intermediate reference value(s) corresponding to the second reference data rate; for the second given intermediate reference value, one of the corresponding multiple values is equal to a maximum RB allocation in a largest bandwidth supported in a given frequency band or frequency band combination.

In one embodiment, the second reference data rate is associated with a largest bandwidth supported by the first PUSCH in a frequency band or frequency band combination to which it belongs.

In one embodiment, the second reference data rate is associated with a maximum RB allocation in a largest bandwidth supported by the first PUSCH in a frequency band or frequency band combination to which it belongs in frequency domain.

In one embodiment, the second reference data rate is associated with a largest bandwidth supported in a serving cell to which the first PUSCH belongs.

In one embodiment, the second reference data rate is associated with a maximum RB allocation in a largest bandwidth supported in a serving cell to which the first PUSCH belongs.

In one embodiment, the second constant is a positive number.

In one embodiment, the second constant is not greater than 1.

In one embodiment, the second constant is 10⁻⁶.

In one embodiment, the second constant is the first constant.

In one embodiment, the second reference data rate is greater than the first reference data rate.

In one embodiment, the second reference data rate is a maximum data rate.

In one embodiment, the second reference data rate is calculated as a maximum data rate for one carrier or a maximum data rate for multiple carriers.

In one embodiment, the second reference data rate is calculated as: in a frequency band or frequency band combination, an approximate maximum data rate of a given number of aggregation carrier(s).

In one embodiment, the second reference data rate is computed as the maximum data rate summed over all the carriers in the frequency range for any signaled band combination and feature set consistent with the configured servings cells.

In one embodiment, the second reference data rate is calculated as a maximum data rate on a carrier.

In one embodiment, the second reference data rate is equal to 10⁻⁶ multiplied by a sum of J intermediate reference value(s), and each of the J intermediate reference value(s) corresponding to the second reference data rate is equal to a product of multiple values.

In one embodiment, when J is equal to 1, a sum of J intermediate reference value(s) refers to: only one intermediate reference value.

In one embodiment, J is equal to 1.

In one embodiment, J is greater than 1.

In one embodiment, J is a number of aggregated component carrier(s) in a frequency band or frequency band combination.

In one embodiment, J is a number of configured serving cell(s) belonging to a frequency range.

In one embodiment, the J intermediate reference value(s) corresponding to the second reference data rate corresponds (respectively correspond) to different component carriers.

In one embodiment, the J intermediate reference value(s) corresponding to the second reference data rate corresponds (respectively correspond) to different serving cells.

In one embodiment, a second given intermediate reference value among the J intermediate reference value(s) corresponding to the second reference data rate is equal to a product of multiple values.

In one embodiment, the second given intermediate reference value is any of the J intermediate reference value(s) corresponding to the second reference data rate.

In one embodiment, the second given intermediate reference value is an intermediate reference value corresponding to a component carrier corresponding to the first PUSCH among the J intermediate reference value(s) corresponding to the second reference data rate.

In one embodiment, the second given intermediate reference value is an intermediate reference value corresponding to a serving cell to which the first PUSCH belongs among the J intermediate reference value(s) corresponding to the second reference data rate.

In one embodiment, for each of the J intermediate reference value(s) corresponding to the second reference data rate, one of the corresponding multiple values is equal to a number of maximum transport layers supported.

In one embodiment, for each of the J intermediate reference value(s) corresponding to the second reference data rate, one of the corresponding multiple values is equal to a number of maximum modulation orders supported.

In one embodiment, for each of the J intermediate reference value(s) corresponding to the second reference data rate, one of the corresponding multiple values is a scaling factor.

In one embodiment, for each of the J intermediate reference value(s) corresponding to the second reference data rate, one of the corresponding multiple values is constant 948/1024.

In one embodiment, for each of the J intermediate reference value(s) corresponding to the second reference data rate, one of the corresponding multiple values is constant 12.

In one embodiment, for each of the J intermediate reference value(s) corresponding to the second reference data rate, one of the corresponding multiple values is equal to 1/T2, and T2 is an average OFDM symbol duration in a subframe.

In one embodiment, for each of the J intermediate reference value(s) corresponding to the second reference data rate, one of the corresponding multiple values is equal to 1−OH2, where OH2 is overhead.

In one embodiment, for each of the J intermediate reference value(s) corresponding to the second reference data rate, one of the multiple corresponding values is equal to a maximum RB allocation in a largest bandwidth supported in a given band or a band combination.

In one embodiment, for each of the J intermediate reference value(s) corresponding to the second reference data rate, one of the multiple corresponding values is equal to a maximum RB allocation in a largest bandwidth supported in a given band or a band combination or a maximum RB allocation in a maximum transmission bandwidth of a PUSCH.

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the second given intermediate reference value, one of the corresponding multiple values is configured by a transmitting end of the first signaling.

In one embodiment, for the second given intermediate reference value, one of the corresponding multiple values is reported by the first node.

In one embodiment, for the second given intermediate reference value, one of the corresponding multiple values is provided by the first node.

In one embodiment, for each of the J intermediate reference value(s) corresponding to the second reference data rate, one of the corresponding multiple values is UE-capability related.

In one embodiment, for each of the J intermediate reference value(s) corresponding to the second reference data rate, one of the corresponding multiple values is a parameter value in a UE capability information element.

In one embodiment, the second reference data rate is determined by information configured by a transmitting end of the first signaling, or determined by information reported by the first node, or determined together by information reported by the first node and information configured by a transmitting end of the first signaling.

In one embodiment, the first reference data rate is equal to a product of a first scaling factor and the second reference data rate.

In one embodiment, the first reference data rate is equal to a product of a first scaling factor and the second reference data rate, and the first scaling factor is a non-negative number less than 1.

In one embodiment, the first scaling factor is configurable.

In one embodiment, the first scaling factor is reported by the first node.

In one embodiment, the first scaling factor is pre-configured.

In one embodiment, the first scaling factor is a constant.

In one embodiment, the first scaling factor is a positive number less than 1.

In one embodiment, the first scaling factor is indicated by parameters in an information element.

In one embodiment, the first scaling factor is indicated by a field in an information element.

In one embodiment, the first reference data rate is equal to a product of a first scaling factor and the second reference data rate, and the first scaling factor is configurable.

In one embodiment, the first reference data rate is equal to a product of a first scaling factor and the second reference data rate, and the first scaling factor is provided by the first node.

In one embodiment, the first reference data rate is equal to a product of a first scaling factor and the second reference data rate, and the first scaling factor is determined based on information provided by the first node.

In one embodiment, the first reference data rate is associated with a maximum transmission bandwidth of a PUSCH.

In one embodiment, the second reference data rate is associated with a maximum transmission bandwidth configuration or a largest bandwidth supported in a given band or a band combination.

### Embodiment 13

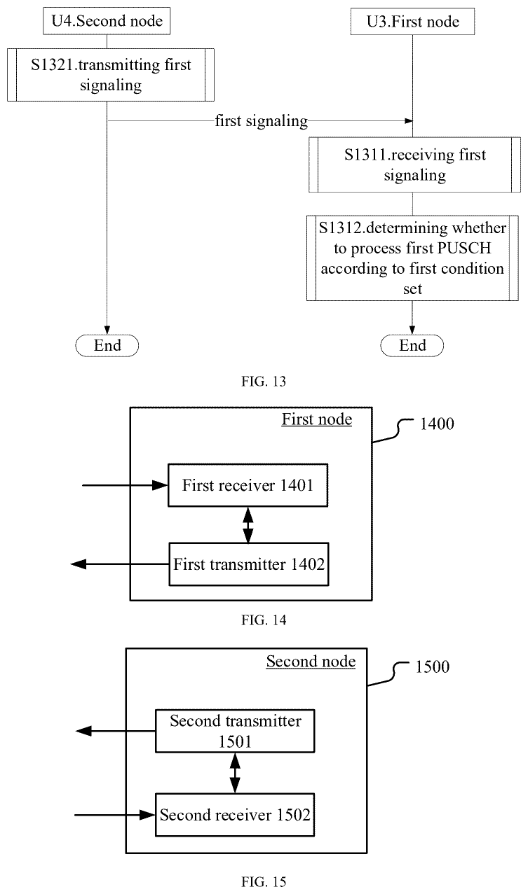

Embodiment 13 illustrates a flowchart of signal transmission according to one embodiment in the present application, as shown in FIG. 13. In FIG. 13, a first node U3 and a second node U4 are in communications via an air interface.

The first node U3 receives a first signaling in step S1311; determines whether to process a first PUSCH according to a first condition set in step S1312.

The second node U4 transmits a first signaling in step S1321.

In embodiment 13, the first signaling is used to schedule the first PUSCH; when the first condition set is satisfied, process the first PUSCH; when the first condition set is not satisfied, determine whether to process the first PUSCH by itself; the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is associated with a maximum transmission bandwidth of a PUSCH; when a second condition set is not satisfied, the target reference data rate is a second reference data rate, and the second reference data rate is associated with a maximum transmission bandwidth configuration or a largest bandwidth supported in a given band or a band combination; the second condition set is related to a maximum transmission bandwidth of PUSCH.

In one subembodiment of embodiment 13, the second condition set comprises: first information is received, and the first information is used to indicate a maximum transmission bandwidth of a PUSCH.

In one subembodiment of embodiment 13, the second condition set comprises: first information is provided, and the first information is used to indicate a maximum transmission bandwidth of a PUSCH.

In one subembodiment of embodiment 13, the second condition set comprises: first information is received, and the first information is used to indicate that a transmission bandwidth of a PUSCH is limited.

In one subembodiment of embodiment 13, the second condition set comprises: first information is provided, and the first information is used to indicate that a transmission bandwidth of a PUSCH is limited.

In one embodiment, the first node U3 is the first node in the present application.

In one embodiment, the second node U4 is the second node in the present application.

In one embodiment, the first node U3 is a UE.

In one embodiment, the first node U3 is a base station.

In one embodiment, the second node U4 is a base station.

In one embodiment, the second node U4 is a UE.

In one embodiment, an air interface between the second node U4 and the first node U3 is a Uu interface.

In one embodiment, an air interface between the second node U4 and the first node U3 comprises a cellular link.

In one embodiment, an air interface between the second node U4 and the first node U3 is a PC5 interface.

In one embodiment, an air interface between the second node U4 and the first node U3 comprises sidelink.

In one embodiment, an air interface between the second node U4 and the first node U3 comprises a radio interface between a base station and a UE.

In one embodiment, an air interface between the second node U4 and the first node U3 comprises a radio interface between a satellite and a UE.

In one embodiment, an air interface between the second node U4 and the first node U3 comprises a radio interface between a UE and a UE.

In one embodiment, a problem to be solved in the present application comprises: how to achieve adaptation to the handling of the PUSCH based on UE capabilities.

In one embodiment, a problem to be solved in the present application comprises: how to determine a data rate that UE needs to process when a transmission bandwidth of a PUSCH is limited.

In one embodiment, a problem to be solved in the present application comprises: how to determine data rate that the UE needs to process based on its capabilities.

In one embodiment, a problem to be solved in the present application comprises: how to determine whether to process a PUSCH based on data rate for different UE capabilities.

In one embodiment, a problem to be solved in the present application comprises: how to achieve support for reduced capacity terminal devices.

In one embodiment, the first information is information of a component carrier corresponding to the first PUSCH or a serving cell to which it belongs.

In one embodiment, the second condition set not being satisfied comprises: the first node does not receive the first information.

In one embodiment, the second condition set comprises: first information is received, and the first information is used to indicate that a transmission bandwidth of a PUSCH is limited.

In one embodiment, the phrase that a transmission bandwidth of a PUSCH is limited comprises: a maximum transmission bandwidth of a PUSCH is less than a largest bandwidth supported.

In one embodiment, the second condition set not being satisfied comprises: the first information is received, and the first information does not indicate that a transmission bandwidth of the PUSCH is limited.

In one embodiment, the second condition set not being satisfied comprises: the first information is not received, or the first information is received and the first information does not indicate that a transmission bandwidth of a PUSCH is limited.

In one embodiment, the second condition set not being satisfied comprises: the first node does not transmit the first information.

In one embodiment, the second condition set comprises: first information is transmitted, and the first information is used to indicate that a transmission bandwidth of a PUSCH is limited.

In one embodiment, the second condition set not being satisfied comprises: the first information is transmitted, and the first information does not indicate that a transmission bandwidth of a PUSCH is limited.

In one embodiment, the second condition set not being satisfied comprises: the first information is not transmitted, or the first information is transmitted and the first information does not indicate that a transmission bandwidth of a PUSCH is limited.

In one embodiment, the second condition set comprises: first information is provided, and the first information is used to indicate a maximum transmission bandwidth of a PUSCH.

In one embodiment, the second condition set not being satisfied comprises: the first information is not provided.

In one embodiment, the second condition set comprises: first information is provided, and the first information is used to indicate that a transmission bandwidth of a PUSCH is limited.

In one embodiment, the second condition set not being satisfied comprises: the first information is provided, and the first information does not indicate that a transmission bandwidth of a PUSCH is limited.

In one embodiment, the second condition set not being satisfied comprises: the first information is not provided, or the first information is provided and the first information does not indicate that a transmission bandwidth of a PUSCH is limited.

In one embodiment, if the first node does not provide the first information, then the second condition set is not satisfied.

In one embodiment, only when the third condition set is satisfied, the first node in the present application determines whether to process the first PUSCH according to the first condition set.

In one embodiment, a third condition set is a subset of the first condition set.

In one embodiment, when the third condition set is not satisfied, the first node determines whether to process the first PUSCH by itself.

In one embodiment, when all conditions in the third condition set are satisfied, the third condition set is satisfied.

In one embodiment, when any condition in the third condition set is satisfied, the third condition set is not satisfied.

In one embodiment, the third condition set comprises only one condition.

In one embodiment, the third condition set comprises multiple conditions.

In one embodiment, claims in the present application are for the case where a third condition set is satisfied.

In one embodiment, one condition in the third condition set is related to a number of code block(s) comprised in the first PUSCH.

In one embodiment, one condition in the third condition set is related to time-domain resources allocated to the first PUSCH.

In one embodiment, the third condition set comprises: a second actual data rate is not greater than a third reference data rate.

In one embodiment, the second actual data rate is equal to a sum of J1 intermediate value(s), J1 being a positive integer, and one of the J1 intermediate value(s) is related to the number of bit(s) in the bit block in the first PUSCH.

In one embodiment, the number of bit(s) in the bit block in the first PUSCH is used to determine the second actual data rate.

In one embodiment, the number of bit(s) in the bit block in the first PUSCH is used to calculate the second actual data rate.

In one embodiment, the second actual data rate is linearly correlated with the number of bit(s) in the bit block in the first PUSCH.

In one embodiment, the second actual data rate is equal to

$${\sum }_{j = 0}^{J - 1} \frac{{\sum }_{m = 0}^{M - 1} {V}_{j , m}}{{T}_{slot}^{μ ( j )}} ,$$

j is one of 0, 1, . . . , J−1, each j corresponds to a serving cell, where J is a number of configured serving cell(s) belonging to a frequency range.

In one subembodiment of the above embodiment, for a j-th serving cell: M is a number of transport block(s) transmitted in a corresponding slot; Tₛₗₒₜ^{μ(j)}=10⁻³/2^{μ(j)}, where μ(j) is a parameter numerology of a PUSCH in a corresponding slot; for an m-th transport block,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block; the bit block in the first PUSCH is one of the M transport block(s).

In one embodiment, for a j-th serving cell, the corresponding slot is a slot overlapping with any given time point.

In one embodiment, the second actual data rate is equal to

$$\frac{{\sum }_{m = 0}^{M - 1} {v}_{j , m}}{L \times {T}_{s}^{μ}} ,$$

j corresponds to a serving cell to which the first PUSCH belongs, L is a number of symbol(s) allocated to the first PUSCH, M is a number of transport block(s) in the first PUSCH,

$${T}_{s}^{μ} = \frac{{10}^{- 3}}{{2}^{μ} \cdot {N}_{symb}^{slot}} ,$$

where μ is a parameter numerology of the first PUSCH; for an m-th transport block in the first PUSCH,

$${V}_{j , m} = {C}^{′} \cdot ⌊ \frac{A}{C} ⌋ ,$$

where A is a number of bit(s) in this transport block, C is a total number of code block(s) for this transport block, and C′ is a number of code block(s) scheduled for this transport block.

In one embodiment, the third reference data rate is equal to a third constant multiplied by a sum of J1 intermediate reference values, each intermediate reference value in the J1 intermediate reference values corresponding to the third reference data rate is equal to a product of multiple values, and the J1 intermediate reference values corresponding to the third reference data rate corresponds (respectively correspond) to different component carriers or different serving cells; a third given intermediate reference value is an intermediate reference value corresponding to a component carrier corresponding to the first PUSCH or a serving cell where the first PUSCH is located among the J1 intermediate reference values corresponding to the third reference data rate; for the third given intermediate reference value, one of the corresponding multiple values is equal to a maximum RB allocation in a largest bandwidth supported in a given frequency band or frequency band combination.

In one embodiment, the third reference data rate is associated with a largest bandwidth supported by the first PUSCH in a frequency band or frequency band combination to which it belongs in frequency domain.

In one embodiment, the third reference data rate is associated with a maximum RB allocation supported by the first PUSCH in a frequency band or frequency band combination to which it belongs in frequency domain.

In one embodiment, the third reference data rate is associated with a largest bandwidth supported in a serving cell to which the first PUSCH belongs.

In one embodiment, the third reference data rate is associated with a maximum RB allocation in a largest bandwidth supported in a serving cell to which the first PUSCH belongs.

In one embodiment, the third constant is a positive number.

In one embodiment, the third constant is not greater than 1.

In one embodiment, the third constant is 10⁻⁶.

In one embodiment, the third reference data rate is a maximum data rate.

In one embodiment, the third reference data rate is calculated as a maximum data rate for one carrier or a maximum data rate for multiple carriers.

In one embodiment, the third reference data rate is calculated as: in a frequency band or frequency band combination, an approximate maximum data rate of a given number of aggregation carrier(s).

In one embodiment, the third reference data rate is computed as the maximum data rate summed over all the carriers in the frequency range for any signaled band combination and feature set consistent with the configured servings cells.

In one embodiment, the third reference data rate is calculated as a maximum data rate on a carrier.

In one embodiment, the third reference data rate is equal to 10⁻⁶ multiplied by a sum of J1 intermediate reference value(s), and each intermediate reference value in the J1 intermediate reference value(s) corresponding to the third reference data rate is equal to a product of multiple values.

In one embodiment, when J1 is equal to 1, a sum of J1 intermediate reference value(s) refers to: only one intermediate reference value.

In one embodiment, J1 is equal to 1.

In one embodiment, J1 is greater than 1.

In one embodiment, J1 is equal to J.

In one embodiment, J1 is not equal to J.

In one embodiment, J1 is a number of aggregated component carrier(s) in a frequency band or frequency band combination.

In one embodiment, J1 is a number of configured serving cell(s) belonging to a frequency range.

In one embodiment, the J1 intermediate reference value(s) corresponding to the third reference data rate corresponds (respectively correspond) to different component carriers.

In one embodiment, the J1 intermediate reference value(s) corresponding to the third reference data rate corresponds (respectively correspond) to different serving cells.

In one embodiment, a third given intermediate reference value among the J intermediate reference value(s) corresponding to the third reference data rate is equal to a product of multiple values.

In one embodiment, the third given intermediate reference value is any of the J1 intermediate reference value(s) corresponding to the third reference data rate.

In one embodiment, the third given intermediate reference value is an intermediate reference value corresponding to a component carrier corresponding to the first PUSCH among the J1 intermediate reference value(s) corresponding to the third reference data rate.

In one embodiment, the third given intermediate reference value is an intermediate reference value corresponding to a serving cell to which the first PUSCH belongs among the J1 intermediate reference value(s) corresponding to the third reference data rate.

In one embodiment, for each of the J1 intermediate reference value(s) corresponding to the third reference data rate, one of the corresponding multiple values is equal to a number of maximum transport layers supported.

In one embodiment, for each of the J1 intermediate reference value(s) corresponding to the third reference data rate, one of the corresponding multiple values is equal to a number of maximum modulation orders supported.

In one embodiment, for each of the J1 intermediate reference value(s) corresponding to the third reference data rate, one of the corresponding multiple values is a scaling factor.

In one embodiment, for each of the J1 intermediate reference value(s) corresponding to the third reference data rate, one of the corresponding multiple values is constant 948/1024.

In one embodiment, for each of the J1 intermediate reference value(s) corresponding to the third reference data rate, one of the corresponding multiple values is constant 12.

In one embodiment, for each of the J1 intermediate reference value(s) corresponding to the third reference data rate, one of the corresponding multiple values is equal to 1/T3, and the T3 is an average OFDM symbol duration in a subframe.

In one embodiment, for each of the J1 intermediate reference value(s) corresponding to the third reference data rate, one of the corresponding multiple values is equal to 1−OH3, and the OH3 is overhead.

In one embodiment, for each of the J1 intermediate reference value(s) corresponding to the third reference data rate, one of the multiple corresponding values is equal to a maximum RB allocation in a largest bandwidth supported in a given band or a band combination.

In one embodiment, for each of the J1 intermediate reference value(s) corresponding to the third reference data rate, one of the multiple corresponding values is equal to a maximum RB allocation in a largest bandwidth supported in a given band or a band combination or a maximum RB allocation in a maximum transmission bandwidth of a PUSCH.

In one embodiment, the phrase of maximum RB allocation comprises: a maximum number of resource block allocation(s).

In one embodiment, the phrase of maximum RB allocation comprises: a maximum number of resource block(s) that can be allocated.

In one embodiment, for the third given intermediate reference value, one of the corresponding multiple values is configured by a transmitting end of the first signaling.

In one embodiment, for the third given intermediate reference value, one of the corresponding multiple values is reported by the first node.

In one embodiment, for the third given intermediate reference value, one of the corresponding multiple values is provided by the first node.

In one embodiment, for each of the J1 intermediate reference value(s) corresponding to the third reference data rate, one of the corresponding multiple values is related to the UE capability.

In one embodiment, for each of the J1 intermediate reference value(s) corresponding to the third reference data rate, one of the corresponding multiple values is a parameter value in a UE capability information element.

In one embodiment, the third reference data rate is determined by information configured by a transmitting end of the first signaling, or determined by information reported by the first node, or determined together by information reported by the first node and information configured by a transmitting end of the first signaling.

In one embodiment, when the second condition set is satisfied; for a serving cell to which the first PUSCH belongs, a maximum transmission bandwidth of a PUSCH supported is less than a largest bandwidth supported.

### Embodiment 14

Embodiment 14 illustrates a structure block diagram of a processor in a first node, as shown in FIG. 14. In FIG. 14, a processor 1400 in a first node comprises a first receiver 1401 and a first transmitter 1402.

In one embodiment, the first node 1400 is a base station.

In one embodiment, the first node 1400 is a UE.

In one embodiment, the first node 1400 is a relay node.

In one embodiment, the first node 1400 is a vehicle-mounted communication device.

In one embodiment, the first node 1400 is a UE that supports V2X communications.

In one embodiment, the first node 1400 is a relay node that supports V2X communications.

In one embodiment, the first node 1400 is a reduced capability UE.

In one embodiment, the first receiver 1401 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1401 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1401 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1401 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1401 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1402 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1402 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1402 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1402 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1402 comprises at least first two of the antenna 452, the transmitter 454, the multi-antenna transmitting processor 457, the transmitting processor 468, the controller/processor 459, the memory 460, and the data source 467 in FIG. 4 of the present application.

In one embodiment, the first receiver 1401 receives a first signaling, and the first signaling is used to schedule a first PDSCH; determines whether to process the first PDSCH according to a first condition set; when the first condition set is satisfied, processes the first PDSCH; when the first condition set is not satisfied, determines whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one embodiment, the first reference data rate is equal to a product of a first scaling factor and the second reference data rate, and the first scaling factor is a non-negative number less than 1.

In one embodiment, the first reference data rate is associated with a maximum transmission bandwidth of a PDSCH.

In one embodiment, the second reference data rate is associated with a maximum transmission bandwidth configuration or a largest bandwidth supported in a given band or a band combination.

In one embodiment, the second condition set comprises: first information is received, and the first information is used to indicate a maximum transmission bandwidth of a PDSCH.

In one embodiment, the second condition set comprises: first information is transmitted, and the first information is used to indicate a maximum transmission bandwidth of a PDSCH.

In one embodiment, the second condition set comprises: first information is provided, and the first information is used to indicate a maximum transmission bandwidth of a PDSCH.

In one embodiment, when the second condition set is satisfied: for a serving cell to which the first PDSCH belongs, a maximum transmission bandwidth of a PDSCH supported is less than a largest bandwidth supported.

In one embodiment, the behavior of processing the first PDSCH comprises decoding a bit block in the first PDSCH.

In one embodiment, the first receiver 1401 receives a first signaling, and the first signaling is used to schedule a first PUSCH; the first node determines whether to process the first PUSCH according to a first condition set; when the first condition set is satisfied, processes the first PUSCH; when the first condition set is not satisfied, determines whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one embodiment, the first reference data rate is equal to a product of a first scaling factor and the second reference data rate, and the first scaling factor is a non-negative number less than 1.

In one embodiment, the first reference data rate is associated with a maximum transmission bandwidth of a PUSCH.

In one embodiment, the second reference data rate is associated with a maximum transmission bandwidth configuration or a largest bandwidth supported in a given band or a band combination.

In one embodiment, the second condition set comprises: first information is received, and the first information is used to indicate a maximum transmission bandwidth of a PUSCH.

In one embodiment, the second condition set comprises: first information is transmitted, and the first information is used to indicate a maximum transmission bandwidth of a PUSCH.

In one embodiment, the second condition set comprises: first information is provided, and the first information is used to indicate a maximum transmission bandwidth of a PUSCH.

In one embodiment, when the second condition set is satisfied: for a serving cell to which the first PUSCH belongs, a maximum transmission bandwidth of a PUSCH supported is less than a largest bandwidth supported.

In one embodiment, when the first node determines processing the first PUSCH, the first transmitter 1402 transmits the first PUSCH.

### Embodiment 15

Embodiment 15 illustrates a structure block diagram of a processor in a second node, as shown in FIG. 15. In FIG. 15, a processor 1500 in the second node comprises a second transmitter 1501 and a second receiver 1502.

In one embodiment, the second node 1500 is a UE.

In one embodiment, the second node 1500 is a base station.

In one embodiment, the second node 1500 is satellite.

In one embodiment, the second node 1500 is a relay node.

In one embodiment, the second node 1500 is a vehicle-mounted communication device.

In one embodiment, the second node 1500 is a UE supporting V2X communications.

In one embodiment, the second transmitter 1501 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1501 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1501 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1501 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1501 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1502 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1502 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1502 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1502 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1502 comprises at least first two of the antenna 420, the receiver 418, the multi-antenna receiving processor 472, the receiving processor 470, the controller/processor 475 and the memory 476 in FIG. 4 of the present application.

In one embodiment, the second transmitter 1501 transmits the first signal, and the first signaling is used to schedule a first PDSCH; a receiving end of the first signaling determines whether to process the first PDSCH according to a first condition set; when the first condition set is satisfied, processes the first PDSCH; when the first condition set is not satisfied, determines whether to process the first PDSCH by itself; herein, the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

In one embodiment, the first reference data rate is equal to a product of a first scaling factor and the second reference data rate, and the first scaling factor is a non-negative number less than 1.

In one embodiment, the first reference data rate is associated with a maximum transmission bandwidth of a PDSCH.

In one embodiment, the second reference data rate is associated with a maximum transmission bandwidth configuration or a largest bandwidth supported in a given band or a band combination.

In one embodiment, the second condition set comprises: first information is received by a receiving end of the first signaling, and the first information is used to indicate a maximum transmission bandwidth of a PDSCH.

In one embodiment, the second condition set comprises: first information is transmitted by a receiving end of the first signaling, and the first information is used to indicate a maximum transmission bandwidth of a PDSCH.

In one embodiment, the second condition set comprises: first information is provided by a receiving end of the first signaling, and the first information is used to indicate a maximum transmission bandwidth of a PDSCH.

In one embodiment, when the second condition set is satisfied; for a serving cell to which the first PDSCH belongs, a maximum transmission bandwidth of a PDSCH supported is less than a largest bandwidth supported.

In one embodiment, the behavior of processing the first PDSCH comprises decoding a bit block in the first PDSCH.

In one embodiment, the second transmitter 1501 transmits the first PDSCH;

In one embodiment, the second transmitter 1501 transmits the first signaling, and the first signaling is used to schedule a first PUSCH; a receiving end of the first signaling determines whether to process the first PUSCH according to a first condition set; when the first condition set is satisfied, processes the first PUSCH; when the first condition set is not satisfied, determines whether to process the first PUSCH by itself; herein, the first condition set comprises that an actual data rate is not greater than a target reference data rate; the actual data rate is related to a number of bit(s) in a bit block in the first PUSCH; when the second condition set is satisfied, the target reference data rate is a first reference data rate, and the first reference data rate is configurable or UE-capability related; when the second condition set is not satisfied, the target reference data rate is a second reference data rate, and the second reference data rate is configurable or UE-capability related; the second condition set is related to a transmission bandwidth of PUSCH.

In one embodiment, the first reference data rate is equal to a product of a first scaling factor and the second reference data rate, and the first scaling factor is a non-negative number less than 1.

In one embodiment, the first reference data rate is associated with a maximum transmission bandwidth of a PUSCH.

In one embodiment, the second reference data rate is associated with a maximum transmission bandwidth configuration or a largest bandwidth supported in a given band or a band combination.

In one embodiment, the second condition set comprises: first information is received by a receiving end of the first signaling, and the first information is used to indicate a maximum transmission bandwidth of a PUSCH.

In one embodiment, the second condition set comprises: first information is transmitted by a receiving end of the first signaling, and the first information is used to indicate a maximum transmission bandwidth of a PUSCH.

In one embodiment, the second condition set comprises: first information is provided by a receiving end of the first signaling, and the first information is used to indicate a maximum transmission bandwidth of a PUSCH.

In one embodiment, when the second condition set is satisfied; for a serving cell to which the first PUSCH belongs, a maximum transmission bandwidth of a PUSCH supported is less than a largest bandwidth supported.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to schedule a first PDSCH; determining whether to process the first PDSCH according to a first condition set; when the first condition set is satisfied, processing the first PDSCH; when the first condition set is not satisfied, determining whether to process the first PDSCH by itself;
wherein the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

2. The first node according to claim 1, wherein the first reference data rate is equal to a ratio of the second reference data rate to a first scaling factor, and the first scaling factor is a positive number larger than 1.

3. The first node according to claim 1, wherein the first reference data rate is associated with a maximum transmission bandwidth of a PDSCH.

4. The first node according to claim 3, wherein the second reference data rate is associated with a maximum transmission bandwidth configuration or a maximum bandwidth supported in a given band or a band combination.

5. The first node according to claim 4, wherein the second condition set is related to a transmission bandwidth of a PDSCH, comprising: the second condition set is related to a maximum transmission bandwidth of a PDSCH.

6. The first node according to claim 5, wherein the second condition set comprises: for a component carrier corresponding to the first PDSCH or a serving cell where the first PDSCH is located, a maximum transmission bandwidth of a PDSCH is configured.

7. The first node according to claim 5, wherein when the second condition set is satisfied: for a band or a band combination where the first PDSCH is located in frequency domain, a supported maximum transmission bandwidth of a PDSCH is less than a maximum bandwidth supported.

8. A second node for wireless communications, comprising:
a second transmitter, transmitting a first signaling, the first signaling being used to schedule a first PDSCH; a receiving end of the first signaling determining whether to process the first PDSCH according to a first condition set; when the first condition set is satisfied, processing the first PDSCH; when the first condition set is not satisfied, determining whether to process the first PDSCH by itself;
wherein the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

9. The second node according to claim 8, wherein the first reference data rate is equal to a ratio of the second reference data rate to a first scaling factor, and the first scaling factor is a positive number larger than 1.

10. The second node according to claim 8, wherein the first reference data rate is associated with a maximum transmission bandwidth of a PDSCH.

11. The second node according to claim 10, wherein the second reference data rate is associated with a maximum transmission bandwidth configuration or a maximum bandwidth supported in a given band or a band combination.

12. The second node according to claim 11, wherein the second condition set is related to a transmission bandwidth of a PDSCH, comprising: the second condition set is related to a maximum transmission bandwidth of a PDSCH.

13. The second node according to claim 12, wherein when the second condition set is satisfied: for a band or a band combination where the first PDSCH is located in frequency domain, a supported maximum transmission bandwidth of a PDSCH is less than a maximum bandwidth supported.

14. A method in a first node for wireless communications, comprising:
receiving a first signaling, the first signaling being used to schedule a first PDSCH; determining whether to process the first PDSCH according to a first condition set; when the first condition set is satisfied, processing the first PDSCH; when the first condition set is not satisfied, determining whether to process the first PDSCH by itself;
wherein the first condition set comprises that an actual data rate is not greater than a target reference data rate; the actual data rate is related to a number of bit(s) in a bit block in the first PDSCH; when a second condition set is satisfied, the target reference data rate is a first reference data rate, and the first reference data rate is configurable or UE-capability related; when a second condition set is not satisfied, the target reference data rate is a second reference data rate, and the second reference data rate is configurable or UE-capability related; the second condition set is related to a transmission bandwidth of a PDSCH.

15. The method in a first node according to claim 14, wherein the first reference data rate is equal to a ratio of the second reference data rate to a first scaling factor, and the first scaling factor is a positive number larger than 1.

16. The method in a first node according to claim 14, wherein the first reference data rate is associated with a maximum transmission bandwidth of a PDSCH.

17. The method in a first node according to claim 16, wherein the second reference data rate is associated with a maximum transmission bandwidth configuration or a maximum bandwidth supported in a given band or a band combination.

18. The method in a first node according to claim 17, wherein the second condition set is related to a transmission bandwidth of a PDSCH, comprising: the second condition set is related to a maximum transmission bandwidth of a PDSCH.

19. The method in a first node according to claim 18, wherein the second condition set comprises: for a component carrier corresponding to the first PDSCH or a serving cell where the first PDSCH is located, a maximum transmission bandwidth of a PDSCH is configured.

20. The method in a first node according to claim 18, wherein when the second condition set is satisfied: for a band or a band combination where the first PDSCH is located in frequency domain, a supported maximum transmission bandwidth of a PDSCH is less than a maximum bandwidth supported.
